(19) United States
(12) Patent Application Publication
(10) Pub. No.: US 2023/0368487 A1
(43) Pub. Date: Nov. 16, 2023

(54) METHOD AND APPARATUS FOR DETECTING FOREIGN OBJECT

(71) Applicant: Panasonic Intellectual Property Management Co., Ltd., Osaka (JP)

(72) Inventors: YOSHIFUMI KARIATSUMARI, Osaka (JP); YUMIKO KATO, Osaka (JP); ATSUSHI ISHIKAWA, Osaka (JP)

(21) Appl. No.: 18/360,958

(22) Filed: Jul. 28, 2023

Related U.S. Application Data
(63) Continuation of application No. PCT/JP2022/004780, filed on Feb. 8, 2022.

(30) Foreign Application Priority Data
Feb. 22, 2021 (JP) 2021-026525

(51) Int. Cl. G06V 10/25; G06T 5/20; G06T 9/00; G06V 10/764; G06V 20/68

(52) U.S. Cl. CPC G06V 10/25; G06T 5/20; G06T 9/00; G06V 10/764; G06V 20/68; G06V 2201/07; G06T 2207/10036

(57) ABSTRACT

A method for detecting a foreign object on or in an object, the method being executed by a computer, includes acquiring image data of the object including information regarding four or more bands, extracting, for individual regions of the object, partial image data corresponding to at least one band among the four or more bands from the image data, performing, for each region, a detection operation for detecting, based on the partial image data, a foreign object on or in the object, and outputting data representing a detection result. The at least one band is selected in accordance with each of the regions.

### BACKGROUND

### 1. Technical Field

The present disclosure relates to a method and an apparatus for detecting a foreign object.

### 2. Description of the Related Art

Inspection of foreign objects on surfaces of industrial products and processed food products has been performed visually by persons. In recent years, inspection of foreign objects on surfaces has increasingly been performed by diagnostic imaging through camera imaging. For example, technologies have been developed to detect foreign objects by appropriately processing image data generated by industrial monochrome or RGB color cameras. Some foreign objects may be similar in shape, color tone, and composition to industrial products and processed food products being inspected. Such foreign objects are easy to miss even visually and are not easily detected even by diagnostic imaging using a monochrome or RGB color camera. Thus, diagnostic imaging using a monochrome or RGB color camera has limited applicability.

In contrast, in diagnostic imaging using an imaging apparatus, such as a hyperspectral camera, that can acquire image information for many wavelengths, even foreign objects such as those described above can be detected. International Publication No. 2019/181845 discloses a processing method for hyperspectral image data in the analysis of living tissue. U.S. Pat. No. 9,599,511 discloses an imaging apparatus that uses compressed-sensing technology to obtain a hyperspectral image of an object.

### SUMMARY

One non-limiting and exemplary embodiment provides a technology for reducing the processing load in foreign object detection.

In one general aspect, the techniques disclosed here feature a method for detecting a foreign object on or in an object, the method being executed by a computer. The method includes acquiring image data of the object including information regarding four or more bands, extracting, for individual regions of the object, partial image data corresponding to at least one band among the four or more bands from the image data, performing, for each region, a detection operation for detecting, based on the partial image data, a foreign object on or in the object, and outputting data representing a detection result. The at least one band is selected in accordance with each of the regions. Wavelength bands may be referred to as bands in the present specification and the drawings.

A general or specific embodiment according to the present disclosure may be realized by a system, an apparatus, a method, an integrated circuit, a computer program, or a computer readable recording medium or by a combination of some or all of a system, an apparatus, a method, an integrated circuit, a computer program, and a recording medium. Examples of the computer readable recording medium include a nonvolatile recording medium such as a compact disc read-only memory (CD-ROM). The apparatus may be formed by one or more devices. In a case where the apparatus is formed by two or more devices, the two or more devices may be arranged in one apparatus or may be arranged in two or more separate apparatuses in a divided manner. In the present specification and the claims, an “apparatus” may refer not only to one apparatus but also to a system formed by apparatuses. The apparatuses included in the “system” may include an apparatus installed at a remote place from the other apparatuses and connected to the other apparatus via a communication network.

According to a technology of the present disclosure, the processing load in foreign object detection can be reduced.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram for describing a relationship between a target wavelength range and bands included in the target wavelength range;

FIG. 1B is a diagram schematically illustrating an example of a hyperspectral image;

FIG. 2A is a diagram schematically illustrating an example of a filter array;

FIG. 2B is a diagram illustrating an example of a transmission spectrum of a first filter included in the filter array illustrated in FIG. 2A;

FIG. 2C is a diagram illustrating an example of a transmission spectrum of a second filter included in the filter array illustrated in FIG. 2A;

FIG. 2D is a diagram illustrating an example of spatial distributions of luminous transmittance of bands included in the target wavelength range;

FIG. 3A is a block diagram schematically illustrating an inspection system according to a first embodiment, which is an exemplary embodiment of the present disclosure;

FIG. 3B is a diagram schematically illustrating an example of the arrangement of an imaging apparatus and an actuator along a production line;

FIG. 4A is a block diagram schematically illustrating a first example of an input apparatus illustrated in FIG. 3A;

FIG. 4B is a block diagram schematically illustrating a second example of the input apparatus illustrated in FIG. 3A;

FIG. 4C is a block diagram schematically illustrating a third example of the input apparatus illustrated in FIG. 3A;

FIG. 5A is a flow chart illustrating an example of an operation of the input apparatus illustrated in FIG. 4A;

FIG. 5B is a diagram schematically illustrating an example of data stored in a storage device illustrated in FIG. 4C;

FIG. 6A is a diagram schematically illustrating a first example of reference data stored in a storage device illustrated in FIG. 3A;

FIG. 6B is a diagram schematically illustrating a second example of the reference data stored in the storage device illustrated in FIG. 3A;

FIG. 6C is a diagram schematically illustrating a third example of the reference data stored in the storage device illustrated in FIG. 3A;

FIG. 7A is a flow chart illustrating an example of an operation of a processing circuit in foreign object inspection;

FIG. 7B is a flow chart illustrating an example of an operation of the processing circuit in Step S104 illustrated in FIG. 7A;

FIG. 7C is a flow chart illustrating an example of an operation of the processing circuit in Step S105 illustrated in FIG. 7A;

FIG. 8A is a diagram illustrating a result obtained by the input apparatus dividing an image of an object into regions;

FIG. 8B is a diagram schematically illustrating reference data in an example;

FIG. 8C is a graph illustrating the reflection spectra of a dark blue fabric and possible foreign objects in a region classified into “dark blue”;

FIG. 9A is a diagram illustrating an image for 750 nm in a case where a sewing needle is present in a region classified into “dark blue”;

FIG. 9B is a diagram illustrating the black-and-white inverted image of FIG. 9A;

FIG. 9C is a diagram illustrating a processed image in a case where a safety pin is present in the region classified into “dark blue”;

FIG. 10 is a block diagram schematically illustrating an inspection system according to a second embodiment, which is an exemplary embodiment of the present disclosure;

FIG. 11A is a block diagram schematically illustrating a first example of an input apparatus illustrated in FIG. 10;

FIG. 11B is a block diagram schematically illustrating a second example of the input apparatus illustrated in FIG. 10;

FIG. 11C is a block diagram schematically illustrating a third example of the input apparatus illustrated in FIG. 10;

FIG. 12A is a diagram schematically illustrating an example of a full-reconstruction table;

FIG. 12B is a diagram schematically illustrating an example of region-specific reconstruction tables;

FIG. 13A is a flow chart illustrating an example of an operation of the processing circuit in foreign object inspection using the full-reconstruction table;

FIG. 13B is a flow chart illustrating an example of an operation of the processing circuit in foreign object inspection using the region-specific reconstruction tables;

FIG. 14A is a diagram for describing a procedure in which, using the input apparatus illustrated in FIG. 11B, a compressed image of a boxed meal is divided into regions, and region contents are specified;

FIG. 14B is a diagram for describing the procedure in which, using the input apparatus illustrated in FIG. 11B, the compressed image of the boxed meal is divided into regions, and region contents are specified;

FIG. 14C is a diagram for describing the procedure in which, using the input apparatus illustrated in FIG. 11B, the compressed image of the boxed meal is divided into regions, and region contents are specified;

FIG. 14D is a diagram for describing the procedure in which, using the input apparatus illustrated in FIG. 11B, the compressed image of the boxed meal is divided into regions, and region contents are specified;

FIG. 14E is a diagram for describing the procedure in which, using the input apparatus illustrated in FIG. 11B, the compressed image of the boxed meal is divided into regions, and region contents are specified;

FIG. 15A is a graph illustrating the reflection spectra of “cooked white rice” and possible foreign objects in a region classified into “cooked white rice”;

FIG. 15B is a diagram schematically illustrating a table representing a relationship between reconstruction bands and processing methods in a region classified into “cooked white rice”;

FIG. 15C is a diagram illustrating an image for 520 nm in a case where a hair (a black hair) is present in a region classified into “cooked white rice”;

FIG. 15D is a diagram illustrating the black-and-white inverted image of FIG. 15C;

FIG. 15E is a diagram illustrating a processed image in a case where a hair (a white hair) is present in a region classified into “cooked white rice”;

FIG. 16A is a graph illustrating the reflection spectra of “dried seaweed” and possible foreign objects in a region classified into “dried seaweed”;

FIG. 16B is a diagram schematically illustrating a table representing a relationship between reconstruction bands and processing methods in a region classified into “dried seaweed”;

FIG. 16C is a diagram illustrating an image for 800 nm in a case where a hair (a black hair) is present in a region classified into “dried seaweed”;

FIG. 16D is a diagram illustrating the black-and-white inverted image of FIG. 16C;

FIG. 17A is a graph illustrating the reflection spectra of “deep-fried chicken” and possible foreign objects in a region classified into “deep-fried chicken”;

FIG. 17B is a diagram schematically illustrating a table representing a relationship between reconstruction bands and processing methods in a region classified into “deep-fried chicken”;

FIG. 17C is a diagram illustrating a processed image in a case where a hair (a brown hair that is highly bleached) is present in a region classified into “deep-fried chicken”;

FIG. 18 is a diagram illustrating coordinate axes and an example of coordinates;

FIG. 19 is a diagram illustrating the positions of pixels in a compressed image, pixel values of the pixels included in the compressed image, data g of the compressed image, the positions of pixels in an image Iₖ corresponding to the wavelength band Wₖ, pixel values of the pixels included in the image Iₖ, and data fₖ of the image Iₖ (k=1, 2, 3, 4);

FIG. 20 is a diagram illustrating pixel values to be calculated and pixel values not to be calculated by a processing circuit and image data obtained by omitting the pixel values not to be calculated;

FIG. 21 is a diagram illustrating a comparison made for f, H, f′, and H′; and

FIG. 22 illustrates A, B, C, and D included in FIG. 21.

### DETAILED DESCRIPTIONS

In the present disclosure, all or some of circuits, units, devices, members, or portions or all or some of the functional blocks of a block diagram may be executed by, for example, one or more electronic circuits including a semiconductor device, a semiconductor integrated circuit (IC), or a large-scale integration circuit (LSI). The LSI or the IC may be integrated onto one chip or may be formed by combining chips. For example, functional blocks other than a storage device may be integrated onto one chip. In this case, the term LSI or IC is used; however, the term to be used may change depending on the degree of integration, and the term “system LSI”, “very large-scale integration (VLSI)”, or “ultra-large-scale integration (ULSI)” may be used. A field-programmable gate array (FPGA) or a reconfigurable logic device that allows reconfiguration of interconnection inside an LSI or setup of a circuit section inside an LSI can also be used for the same purpose, the FPGA and the reconfigurable logic device being programmed after the LSIs are manufactured.

Furthermore, functions or operations of all or some of the circuits, the units, the devices, the members, or the portions can be executed through software processing. In this case, software is recorded in one or more non-transitory recording mediums such as a read-only memory (ROM), an optical disc, or a hard disk drive, and when the software is executed by a processing device (a processor), the function specified by the software is executed by the processing device and peripheral devices. The system or the apparatus may have the one or more non-transitory recording mediums in which the software is recorded, a processing device (a processor), and a hardware device to be needed such as an interface.

In the following, exemplary embodiments of the present disclosure will be described. Note that any one of embodiments to be described below is intended to represent a general or specific example. Numerical values, shapes, constituent elements, arrangement positions and connection forms of the constituent elements, steps, and the order of steps are examples, and are not intended to limit the present disclosure. Among the constituent elements of the following embodiments, constituent elements that are not described in independent claims representing the most generic concept are described as optional constituent elements. Each drawing is a schematic diagram and is not necessarily precisely illustrated. Furthermore, in each drawing, substantially the same or similar constituent elements are denoted by the same reference signs. Redundant description may be omitted or simplified.

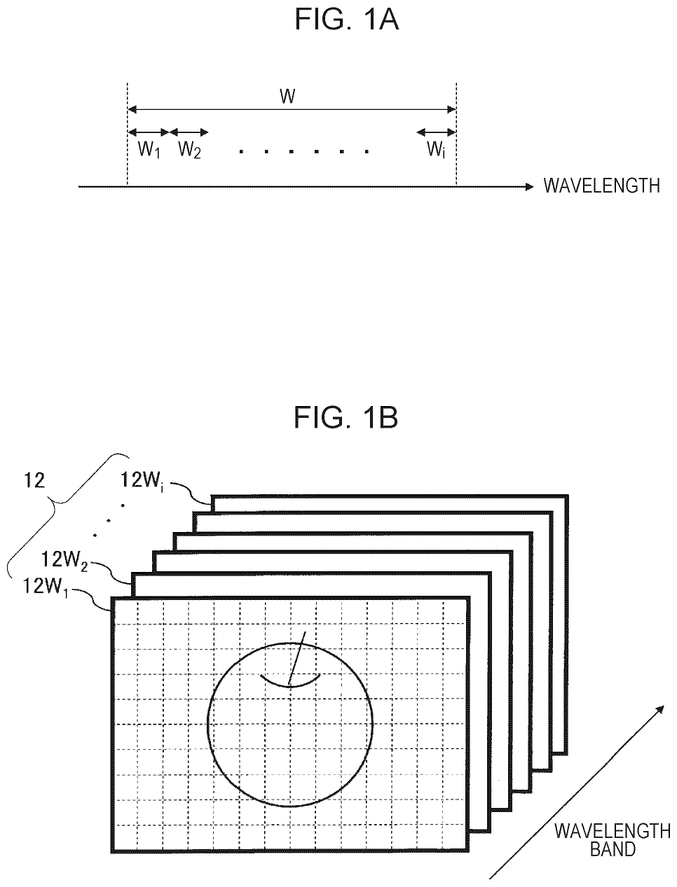

First, an example of a hyperspectral image will be briefly described with reference to FIGS. 1A and 1B. A hyperspectral image is image data having more wavelength information than a typical RGB image. Pixels of an RGB image each have values for three bands, which are red (R), green (G), and blue (B). In contrast, pixels of a hyperspectral image each have values for a greater number of bands than those of an RGB image. In this specification, a “hyperspectral image” refers to image data in which pixels each have values for four or more bands included in a predetermined target wavelength band. A value that each pixel has on a band basis will be referred to as a “pixel value” in the following description. The number of bands in a hyperspectral image is typically 10 or more and may exceed 100 in some cases. A “hyperspectral image” may also be referred to as a “hyperspectral data cube” or a “hyperspectral cube”.

FIG. 1A is a diagram for describing a relationship between a target wavelength range W and bands W₁, W₂, . . . , Wᵢ included in the target wavelength range W. The target wavelength range W may be set to various ranges depending on applications. The target wavelength range W may have, for example, a wavelength range of visible light of about 400 nm to about 700 nm, a wavelength range of near-infrared rays of about 700 nm to about 2500 nm, or a wavelength range of near-ultraviolet rays of about 10 nm to about 400 nm. Alternatively, the target wavelength range W may be the mid-infrared wavelength range or the far-infrared wavelength range. In this manner, a wavelength region used is not limited to the visible light region. In this specification, not only visible light but also electromagnetic waves having wavelengths outside the wavelength range of visible light will be referred to as “light” for convenience' sake. Examples of the electromagnetic waves include ultraviolet rays and near-infrared rays.

In the example illustrated in FIG. 1A, i is set to any integer greater than or equal to 4, the target wavelength range W is equally divided into i wavelength regions, and the i wavelength regions are referred to as a band W₁, a band W₂, . . . , and a band Wᵢ. Note that the example is not limited to this one. The bands included in the target wavelength range W may be freely set. For example, the bands may have different widths. There may be a gap between adjacent bands among the bands. In a case where there are four or more bands, more information can be acquired from a hyperspectral image than from an RGB image.

FIG. 1B is a diagram schematically illustrating an example of a hyperspectral image 12. In the example illustrated in FIG. 1B, an imaging target is an apple. The hyperspectral image 12 includes an image 12W₁ for the band Wᵢ, an image 12W₂ for the band W₂, . . . , and an image 12Wᵢ for the band Wᵢ. Each of these images include pixels arranged two-dimensionally. FIG. 1B illustrates vertical broken lines and horizontal broken lines to represent borders between the pixels. The actual number of pixels per image may be a large value such as several tens of thousands to several tens of millions; however, in FIG. 1B, the borders between the pixels are illustrated supposing that the number of pixels per image is extremely small for convenience' sake. An image sensor has light detection devices, and each light detection device is configured to detect reflected light caused when an object is irradiated with light. For each light detection device, a signal indicating the amount of light detected by the light detection device represents a pixel value of a pixel corresponding to the light detection device. Each pixel of the hyperspectral image 12 has a pixel value for each band. Thus, information regarding a two-dimensional distribution of the spectrum of the object can be obtained by acquiring the hyperspectral image 12. On the basis of the spectrum of the object, optical characteristics of the object can be correctly analyzed.

Next, an example of a method for generating a hyperspectral image will be briefly described. A hyperspectral image can be acquired through imaging performed using, for example, a spectroscopic element such as a prism or a grating. In a case where a prism is used, when reflected light or transmitted light from an object passes through the prism, the light is emitted from a light emission surface of the prism at an emission angle corresponding to the wavelength of the light. In a case where a grating is used, when reflected light or transmitted light from the object is incident on the grating, the light is diffracted at a diffraction angle corresponding to the wavelength of the light. A hyperspectral image can be obtained by separating, using a prism or a grating, light from the object into bands and detecting the separated light on a band basis.

A hyperspectral image can also be acquired using a compressed-sensing technology disclosed in U.S. Pat. No. 9,599,511. In the compressed-sensing technology disclosed in U.S. Pat. No. 9,599,511, light that has passed through a filter array referred to as an encoder and is then reflected by an object is detected by an image sensor. The filter array includes filters arranged two-dimensionally. These filters have transmission spectra unique thereto in a respective manner. Through imaging using such a filter array, one two-dimensional image into which image information regarding bands is compressed is obtained as a compressed image. In the compressed image, the spectrum information regarding the object is compressed and recorded as one pixel value per pixel.

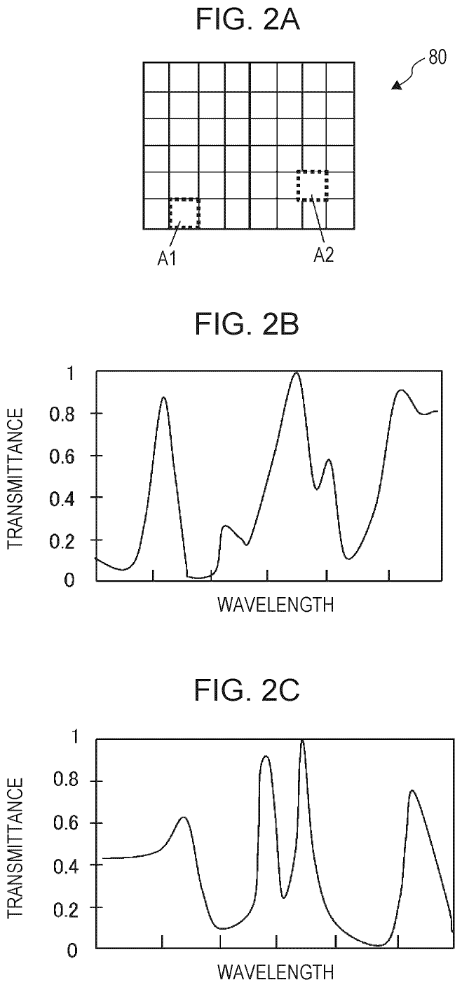

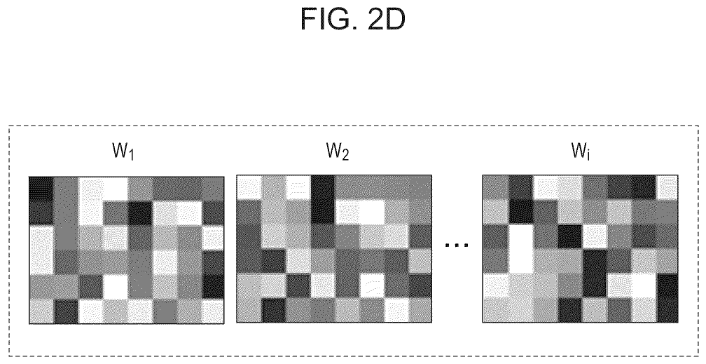

FIG. 2A is a diagram schematically illustrating an example of a filter array 80. The filter array 80 includes filters arranged two-dimensionally. Each filter has a transmission spectrum set individually. The transmission spectrum is expressed by a function T(λ), where the wavelength of incident light is λ. The transmission spectrum T(λ) may have a value greater than or equal to 0 and less than or equal to 1. In the example illustrated in FIG. 2A, the filter array 80 has 48 rectangular filters arranged in 6 rows and 8 columns. This is merely an example, and a larger number of filters than this may be provided in actual applications. The number of filters included in the filter array 80 may be about the same as, for example, the number of pixels of the image sensor.

FIGS. 2B and 2C illustrate the transmission spectrum of a first filter A1 and that of a second filter A2, respectively, among the filters included in the filter array 80 in FIG. 2A. The transmission spectrum of the first filter A1 and that of the second filter A2 are different from each other. In this manner, the transmission spectra of the filters of the filter array 80 are different from each other. Note that the transmission spectra of all the filters are not necessarily different from each other. The transmission spectra of at least two or more filters among the filters are different from each other in the filter array 80. That is, the filter array 80 includes two or more filters that have different transmission spectra from each other. In one example, the number of patterns of the transmission spectra of the filters included in the filter array 80 may be the same as i, which is the number of bands included in the target wavelength range, or greater than or equal to i. The filter array 80 may be designed such that more than half of the filters have different transmission spectra from each other.

FIG. 2D is a diagram illustrating an example of a spatial distribution of luminous transmittance of each of the bands W₁, W₂, . . . , Wᵢ included in the target wavelength range. In the example illustrated in FIG. 2D, differences in shading between the filters represent differences in luminous transmittance. The lighter the shade of the filter, the higher the luminous transmittance. The darker the shade of the filter, the lower the luminous transmittance. As illustrated in FIG. 2D, the spatial distribution of luminous transmittance differs from band to band.

A hyperspectral image can be reconstructed from a compressed image using data representing the spatial distribution of luminous transmittance of each band of the filter array. For reconstruction, compressed-sensing technology is used. The data used in reconstruction processing and representing the spatial distribution of luminous transmittance of each band of the filter array is referred to as a “reconstruction table”. In the compressed-sensing technology, a prism or a grating does not need to be used, and thus a hyperspectral camera can be miniaturized. Furthermore, in the compressed-sensing technology, the amount of data processed by a processing circuit can be reduced by using a compressed image.

Next, a method for reconstructing a hyperspectral image from a compressed image using a reconstruction table will be described. Compressed image data g acquired by the image sensor, a reconstruction table H, and hyperspectral image data f satisfy Eq. (1) below.

g=Hf (1)

In a case where the number of pixels of a compressed image is denoted by N_{g}, the hyperspectral image includes an image for the band W₁, . . . , and an image for a band WM (that is, the number of bands is denoted by M), and the number of pixels of each of the image for the band W₁, . . . , and the image for the band WM is denoted by N_{f}, the compressed image data g can be expressed as a matrix having N_{g} rows and 1 column, the hyperspectral image data f can be expressed as a matrix having N_{f}×M rows and 1 column, and the reconstruction table H can be expressed as a matrix having N_{g} rows and (N_{f}×M) columns. N_{g} and N_{f} can be designed to have the same value.

When the compressed image data g and the matrix H are given, it seems that f can be calculated by solving an inverse problem of Eq. (1). However, the number of elements (N_{f}×M) of the data f to be obtained is greater than the number of elements N_{g} of the acquired data g, and thus this problem is an ill-posed problem, and the problem cannot be solved as is. Thus, the redundancy of the images included in the data f is used to obtain a solution using a compressed-sensing method. Specifically, the data f to be obtained is estimated by solving the following Eq. (2).

$${f}^{′} = {arg min}_{f} \{ {‖ g - Hf ‖}_{{l}_{2}} + τΦ ( f ) \} \qquad ( 2 )$$

In this case, f denotes estimated data of the data f. The first term in the braces of the equation above represents a shift between an estimation result Hf and the acquired data g, which is a so-called residual term. In this case, the sum of squares is treated as the residual term; however, an absolute value, a root-sum-square value, or the like may be treated as the residual term. The second term in the braces is a regularization term or a stabilization term, which will be described later. Eq. (2) means to obtain f that minimizes the sum of the first term and the second term. The processing circuit can cause a solution to converge through a recursive iterative operation and can calculate the final solution f.

The first term in the braces of Eq. (2) refers to a calculation for obtaining the sum of squares of the differences between the acquired data g and Hf, which is obtained by performing a system conversion on f in the estimation process using the matrix H. The second term (KO is a constraint for regularization off and is a function that reflects sparse information regarding the estimated data. This function provides an effect in that estimated data is smoothed or stabilized. The regularization term can be expressed using, for example, discrete cosine transformation (DCT), wavelet transform, Fourier transform, or total variation (TV) of f. For example, in a case where total variation is used, stabilized estimated data can be acquired in which the effect of noise of the data g, observation data, is suppressed. The sparsity of the object in a space of each regularization term differs with the texture of the object. A regularization term having a regularization term space in which the texture of the object becomes sparser may be selected. Alternatively, regularization terms may be included in calculation. τ is a weighting factor. The greater the weighting factor τ, the greater the amount of reduction of redundant data, thereby increasing a compression rate. The smaller the weighting factor τ, the lower the convergence to the solution. The weighting factor τ is set to an appropriate value with which f is converged to a certain degree and is not compressed too much.

A more detailed method for acquiring a hyperspectral image using a compressed-sensing technology is disclosed in U.S. Pat. No. 9,599,511. The entirety of the disclosed content of U.S. Pat. No. 9,599,511 is incorporated herein by reference. Note that a method for acquiring a hyperspectral image through imaging is not limited to the above-described method using compressed sensing. For example, a hyperspectral image may be acquired through imaging using a filter array in which pixel regions including four or more filters having different transmission wavelength ranges from each other are arranged two-dimensionally. Alternatively, a hyperspectral image may be acquired using a spectroscopic method using a prism or a grating.

A hyperspectral camera can be used to inspect, for example, the surface or interior of an item such as an industrial product or a processed food product for the presence of a foreign object. By using a hyperspectral camera, a foreign object that may be overlooked using a monochrome camera or an RGB color camera can be detected. Furthermore, in a case where an appropriate light source is selected, a hyperspectral image can be acquired for a target wavelength range broader than the visible light region. Thus, a foreign object can be detected in a wavelength range that is visually undetectable.

In contrast, hyperspectral image data includes image information for many bands. Thus, hyperspectral image data is greater than monochrome image data and RGB image data in size. Furthermore, in foreign object inspection for industrial products and processed food products having complex configurations, spectral data of an item on or in which a foreign object is not present and which is to be compared with hyperspectral image data may be complicated. Thus, in in-line inspection in which an inspection for the presence of a foreign object is performed, a large high-performance processing circuit is necessary, and much time is spent on processing.

The inventors studied foreign object detection methods with which the processing load of such a processing circuit can be reduced, and have arrived at foreign object detection methods according to the embodiments of the present disclosure. A method according to an embodiment of the present disclosure will be as follows. From hyperspectral image data or compressed image data, partial image data corresponding to at least one band is extracted for each of the regions of an object. “Partial image data” refers to data of part of hyperspectral image data or compressed image data having three-dimensional image information based on a two-dimensional space and wavelengths. “Part” may be part of a space or may also be a part of a wavelength axis. On the basis of the partial image data, a detection operation for detecting a foreign object on or in an object is performed for each region. The size of data handled in single processing can be reduced using a method according to the present embodiment. As a result, the processing load of the processing circuit can be reduced, and appropriate processing speed can be achieved in in-line inspection.

In a method according to International Publication No. 2019/181845, among image data for all the bands included in hyperspectral image data, image data for a band that needs to be analyzed is left, and image data for the other bands is reduced in living tissue analysis. The size of data is reduced in this manner. In contrast, in a foreign object detection method according to the present embodiment, an image is divided into regions, foreign object inspection is performed based on partial image data for a band specified for each region. As described above, the size of data handled in single processing can be reduced compared with the method according to International Publication No. 2019/181845, in which an image is not divided into regions. In the following, a foreign object detection method according to an embodiment of the present disclosure will be briefly described.

A method according to a first aspect is a method for detecting a foreign object on or in an object, the method being executed by a computer. The method includes acquiring image data of the object including information regarding four or more bands, extracting, for individual regions of the object, partial image data corresponding to at least one band among the four or more bands from the image data, performing, for each region, a detection operation for detecting, based on the partial image data, a foreign object on or in the object, and outputting data representing a detection result. The at least one band is selected in accordance with each of the regions.

The processing load in foreign object detection can be reduced using this method.

A method according to a second aspect is the method according to the first aspect in which the acquiring includes acquiring hyperspectral image data representing images of the object for the four or more bands.

By using this method, a foreign object can be detected using the hyperspectral image data.

A method according to a third aspect is the method according to the first aspect in which the acquiring includes acquiring compressed image data obtained by compressing image information regarding the object for the four or more bands into one image.

By using this method, a foreign object can be detected using the compressed image data.

A method according to a fourth aspect is the method according to the third aspect in which the extracting includes reconstructing, from the compressed image data, the partial image data corresponding to the at least one band.

By using this method, compared with a method in which compressed image data is not used and an image is not divided into regions, the number of times processing is performed and the amount of data stored temporarily can be reduced.

A method according to a fifth aspect is the method according to the fourth aspect in which the compressed image data is acquired by imaging the object through a filter array. The filter array has filters arranged two-dimensionally. Transmission spectra of at least two or more filters among the filters differ from each other. The reconstructing includes reconstructing the partial image data using at least one reconstruction table corresponding to the at least one band. The reconstruction table represents a spatial distribution of luminous transmittance of each band for the filter array in each of the regions

By using this method, partial image data corresponding to at least one band can be reconstructed from the compressed image data.

A method according to a sixth aspect is the method according to any one of the first to fifth aspects that further includes acquiring region classification data corresponding to a type of the object. The regions are determined based on the image data and the region classification data.

By using this method, the regions can be determined in accordance with the type of object.

A method according to a seventh aspect is the method according to the sixth aspect in which the at least one band is selected based on the region classification data.

A method according to an eighth aspect is the sixth aspect or the seventh aspect in which the region classification data includes region information for determining the regions, the method further includes acquiring, based on the region classification data, reference data including information regarding a band corresponding to the region information, and the at least one band is selected based on the reference data.

A method according to a ninth aspect is the method according to any one of the sixth to eighth aspects that further includes updating the region classification data, and updating the regions.

By using this method, even in a case where the type of object is changed, the regions can be determined in accordance with the post-change type of object.

A method according to a tenth aspect is the method according to the ninth aspect that further includes updating the at least one band.

By using this method, even in a case where the type of object is changed, partial image data of at least one band can be extracted in accordance with the post-change type of object.

A method according to an eleventh aspect is the method according to any one of the sixth to tenth aspects in which the object is an industrial product, and the region classification data includes data representing a layout diagram of parts of the industrial product.

By using this method, the regions can be determined on the basis of the layout diagram of parts of the industrial product.

A method according to a twelfth aspect is the method according to any one of the sixth to tenth aspects in which the object is a processed food product, and the region classification data includes data representing a layout diagram of ingredients of the processed food product.

By using this method, the regions can be determined on the basis of the layout diagram of ingredients of the processed food product.

A method according to a thirteenth aspect is the method according to any one of the sixth to eleventh aspects in which the region classification data is generated by performing image recognition processing on an image of the object, on or in which a foreign object is not present.

By using this method, the region classification data can be automatically generated through image recognition processing.

A processing apparatus according to a fourteenth aspect is a processing apparatus including a processor and a memory in which a computer program that the processor executes is stored. In order to detect a foreign object on or in an object, the computer program causes the processor to execute: acquiring image data of the object including information regarding four or more bands, extracting, for individual regions of the object, partial image data corresponding to at least one band among the four or more bands from the image data, performing, for each region, a detection operation for detecting, based on the partial image data, a foreign object on or in the object, and outputting data representing a detection result. The at least one band is selected in accordance with each of the regions.

The processing load in foreign object detection can be reduced in this processing apparatus.

### FIRST EMBODIMENT

In an inspection system according to a first embodiment, a foreign object on or in an object is detected using a hyperspectral camera that is not based on a compressed-sensing technology. The summary of a foreign object detection method according to the first embodiment is as follows. Hyperspectral image data of an object to be inspected is acquired. An image represented by the hyperspectral image data is divided into regions. For each of the regions, partial image data corresponding to at least one band among four or more bands included in a target wavelength range is extracted from the hyperspectral image data. A detection operation for detecting a foreign object on or in the object is performed for each region on the basis of the extracted partial image data.

The reflection spectrum of a foreign object may be different from that of the object. Due to the difference between the reflection spectrum of the object and that of a foreign object, in an image represented by the above-described partial image data, the foreign object appears lighter or darker than a region surrounding the foreign object. As a result, the foreign object can be detected. As a band for the partial image data, a band appropriate for foreign object detection is specified on a region basis.

In a case where the object is an industrial product or a processed food product, the type of foreign object is often known prior to inspection. In a case where the object is a garment, foreign objects may include, for example, a sewing needle, a marking pin, or a clip. In a case where the object is a boxed meal, foreign objects may include, for example, a hair or a piece of eggshell. In the following description, suppose that the type of foreign object is known prior to inspection.

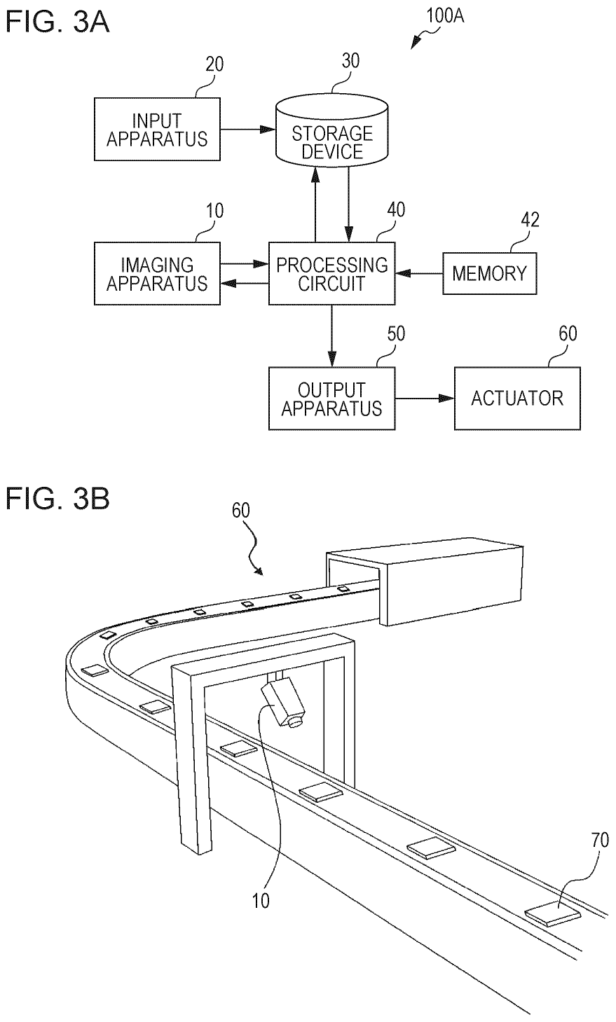

FIG. 3A is a block diagram schematically illustrating an inspection system according to the first embodiment, which is an exemplary embodiment of the present disclosure. An inspection system 100A illustrated in FIG. 3A includes an imaging apparatus 10, an input apparatus 20, a storage device 30, a processing circuit 40, a memory 42, an output apparatus 50, and an actuator 60. The processing circuit 40 controls the operations of the imaging apparatus 10, the storage device 30, and the output apparatus 50.

The imaging apparatus 10 functions as a hyperspectral camera that generates hyperspectral image data of an object through imaging and outputs the hyperspectral image data. The imaging apparatus 10 does not use a compressed-sensing technology. The imaging apparatus 10 may have, for example, an optical system, a spectroscopic element, and an image sensor positioned in this order along an optical path of reflected light from the object or transmitted light through the object. When the distance between the image sensor and the object is a distance A, the distance between the image sensor and the optical system is a distance B, and the distance between the image sensor and the spectroscopic element is a distance C, the distance A may be longer than the distance B, and the distance B may be longer than the distance C. The optical system forms an image on a photodetecting surface of the image sensor. The spectroscopic element separates light coming from the object into bands. The image sensor detects light separated into bands. With this configuration, one-dimensional hyperspectral image data of part of the object along one direction of the object can be obtained in a single imaging session. Two-dimensional hyperspectral image data of the object can be obtained by performing imaging multiple times while shifting the arrangement of the object and the imaging apparatus 10 in stages in a direction perpendicular to the one direction.

The input apparatus 20 is an apparatus that generates various types of data necessary for foreign object inspection and is used before an inspection is performed. Using the input apparatus 20, an image of an object that is of the same type as an object to be inspected and on or in which a foreign object is not present is divided into regions, and region content indicating the shape, color tone, and constituents is specified for each region. In this specification, “regions of the object” refers to regions of an image of the object, the regions being obtained by dividing the image. Region content may be, for example, the color and/or pattern of an industrial product or may be a ready-prepared food and a food material of a processed food product. The input apparatus 20 generates and outputs region classification data representing regions for which region content is specified. The region classification data differs depending on the type of object. The region classification data may be, for example, data representing a layout diagram of parts of an industrial product or data representing a layout diagram of ingredients of a processed food product. The configuration of the input apparatus 20 will be described later.

The storage device 30 stores the region classification data output from the input apparatus 20, the reference data used in foreign object inspection, and data representing a result of foreign object inspection for each region. The reference data includes information regarding a band used for each region, and information on the way in which partial image data for the band is processed. Details of the reference data will be described below. The storage device 30 includes, for example, any storage medium such as a semiconductor memory, a magnetic storage device, or an optical storage device.

The processing circuit 40 acquires the hyperspectral image data from the imaging apparatus 10 and acquires the region classification data and the reference data from the storage device 30. The processing circuit 40 performs, on the basis of these acquired data, an inspection as to whether the object includes a foreign object. In a case where a foreign object is detected, the processing circuit 40 outputs data representing the detection result to the output apparatus 50. A computer program executed by the processing circuit 40 is stored in the memory 42 such as a read-only memory (ROM) or a random access memory (RAM). The processing circuit 40 and the memory 42 function as a processing apparatus. The processing circuit 40 and the memory 42 may be integrated on a single circuit board or may be provided on separate circuit boards.

The output apparatus 50 acquires data representing an inspection result from the processing circuit 40 and outputs information indicating that a foreign object is present on or in the object. This output is performed, for example, by an image display apparatus such as a display displaying an image or text, an audio apparatus such as a speaker outputting a beep or a voice, or a warning light being turned on. Furthermore, the output apparatus 50 transmits a control signal to the actuator 60.

The actuator 60 receives the control signal from the output apparatus 50 and discards an object on or in which a foreign object is present from a production line. The object is discarded by, for example, switching paths of a conveyor belt in the production line or picking the object.

FIG. 3B is a diagram schematically illustrating an example of the arrangement of the imaging apparatus 10 and the actuator 60 in a production line. In the example illustrated in FIG. 3B, the actuator 60 is a conveyor belt and carries objects 70. The imaging apparatus 10 images objects 70 in a sequential manner. The processing circuit 40 performs a foreign object inspection operation on an object 70 among the objects every time imaging is performed.

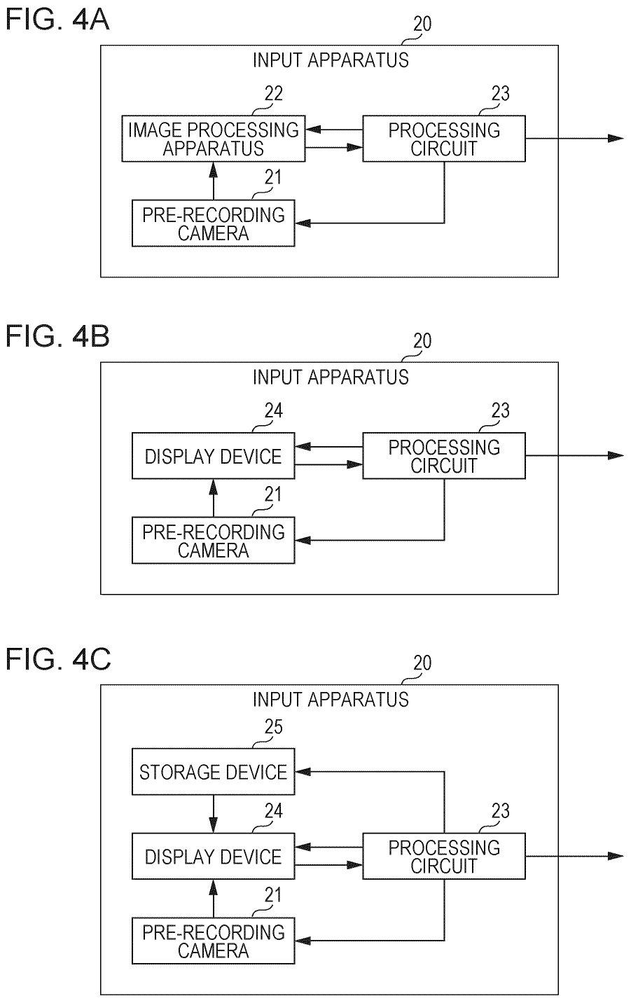

Next, with reference to FIGS. 4A to 4C, an example of the input apparatus 20 illustrated in FIG. 3A will be described. FIGS. 4A to 4C are block diagrams schematically illustrating the example of the input apparatus 20 illustrated in FIG. 3A.

In the example illustrated in FIG. 4A, the input apparatus 20 includes a pre-recording camera 21, an image processing apparatus 22, and a processing circuit 23. The pre-recording camera 21 may be, for example, a monochrome camera or an RGB camera. The image processing apparatus 22 may be, for example, an image recognition apparatus. The image processing apparatus 22 prestores data representing the layout of region contents such as the layout of colors and/or patterns of an industrial product or the layout of ready-prepared foods and/or food materials of a processed food product. The processing circuit 23 causes the pre-recording camera 21 to image an object that is of the same type of an object to be inspected and on or in which a foreign object is not present. The pre-recording camera 21 generates and outputs image data of the object. The processing circuit 23 causes the image processing apparatus 22 to divide an image represented by the image data into regions. The processing circuit 23 causes the image processing apparatus 22 to specify region content for each region on the basis of the stored data representing the layout of region contents. For example, the image processing apparatus 22 determines whether the color pattern of an image represented by RGB image data generated by the pre-recording camera 21 matches the color pattern of the layout of region contents represented by the stored data. In a case where the color patterns match each other, the image processing apparatus 22 specifies region content for each region on the basis of the data for which the color patterns match each other. The processing circuit 23 acquires data output from the image processing apparatus 22 and generates and outputs region classification data representing regions for which region contents have been specified.

In the example illustrated in FIG. 4B, the input apparatus 20 includes the pre-recording camera 21, the processing circuit 23, and a display device 24. The display device 24 displays a graphical user interface (GUI) for the user to divide an image into regions and to specify region contents. The processing circuit 23 causes the display device 24 to display, on the GUI, an image represented by the image data generated by the pre-recording camera 21. The user divides the image displayed on the GUI into regions using a pointing device, and specifies region content for each region. The processing circuit 23 acquires data output from the display device 24 and generates and outputs region classification data representing regions for which region contents have been specified.

In the example illustrated in FIG. 4C, the input apparatus 20 includes the pre-recording camera 21, the processing circuit 23, the display device 24, and a storage device 25. The storage device 25 prestores data representing the layout of region contents. The processing circuit 23 causes the display device 24 to display, on the GUI, an image represented by the image data generated by the pre-recording camera 21 and information regarding the layout of region contents included in the data stored in the storage device 25. The user selects, using a selection switch, the layout of region contents from the information displayed on the GUI. The selection switch may be displayed on the GUI or may be a hard switch. The processing circuit 23 acquires data output from the display device 24 and generates and outputs region classification data representing regions for which region contents have been specified.

The processing circuit 23 included in the input apparatus 20 illustrated in FIGS. 4A to 4C and the processing circuit 40 included in the inspection system 100A may be configured as a single processing circuit.

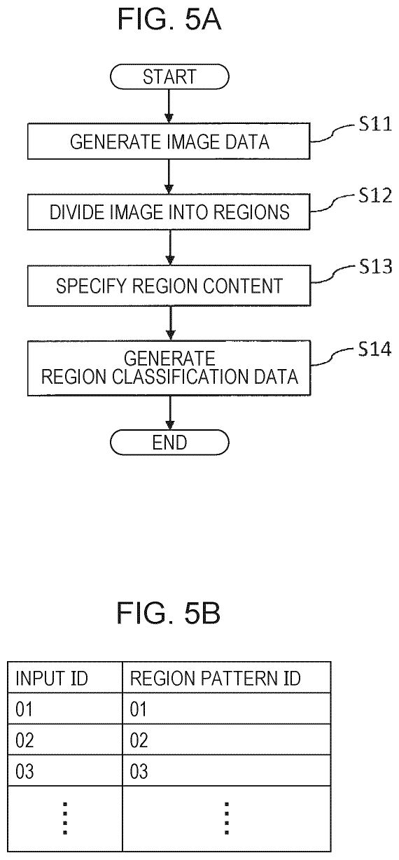

FIG. 5A is a flow chart illustrating an example of an operation of the processing circuit 23 included in the input apparatus 20 illustrated in FIG. 4A. The processing circuit 23 performs operations in Steps S11 to S14 illustrated in FIG. 5A.

Step S11

The processing circuit 23 causes the pre-recording camera 21 to capture an image of an object. The pre-recording camera 21 generates and outputs image data of the object.

Step S12

The processing circuit 23 causes the image processing apparatus 22 to divide an image represented by the image data into regions.

Step S13

The processing circuit 23 causes the image processing apparatus 22 to specify region content for each of the regions obtained as a result of the division.

Step S14

The processing circuit 23 acquires data output from the image processing apparatus 22 and generates and outputs region classification data.

FIG. 5B is a diagram schematically illustrating an example of data stored in the storage device 25 illustrated in FIG. 4C. The data illustrated in FIG. 5B includes a table that represents a relationship between input IDs and region pattern IDs associated with the input IDs. Each region pattern ID is an ID for identifying a region pattern defined in accordance with a layout pattern of region contents. The user selects, using a selection switch, an input ID displayed on the GUI of the display device 24 to determine a region pattern ID.

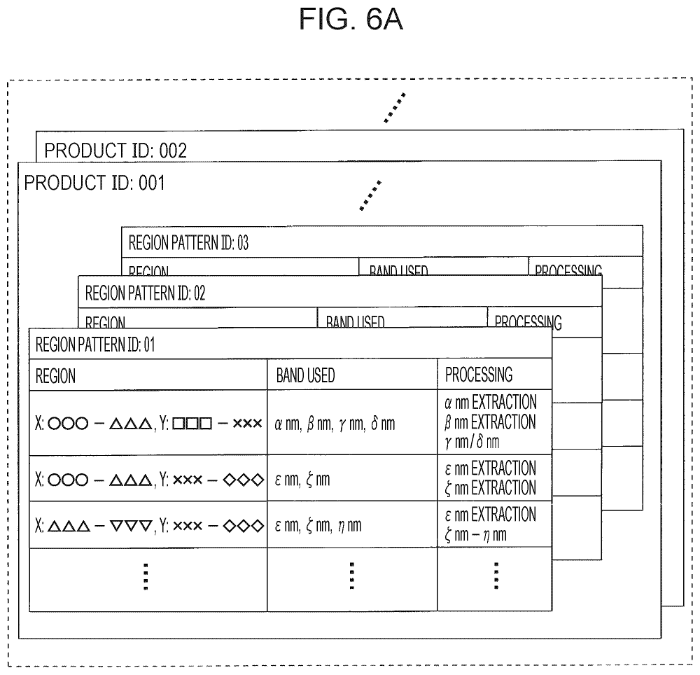

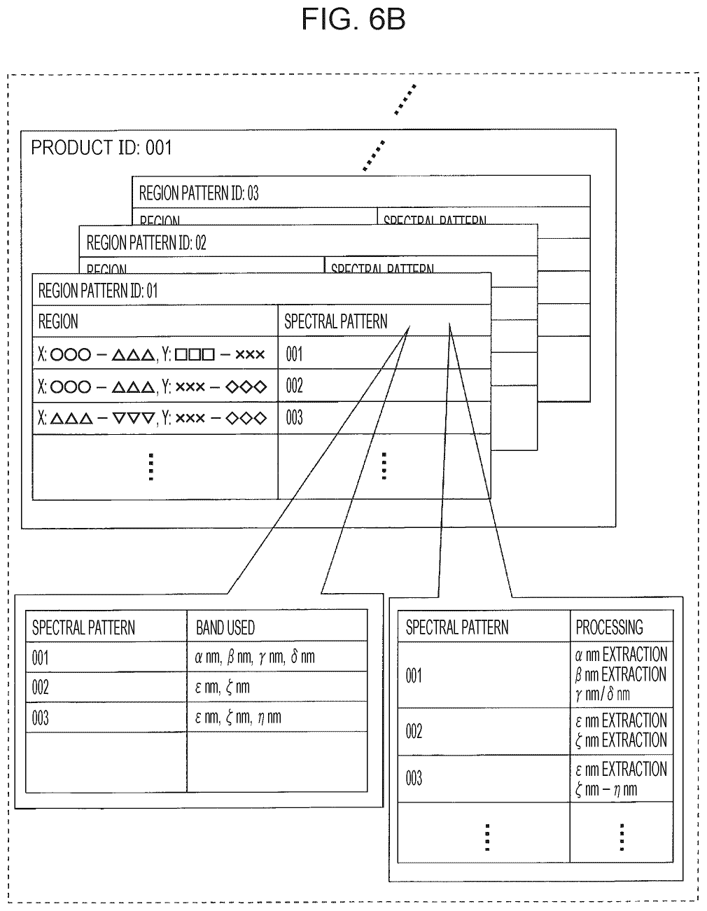

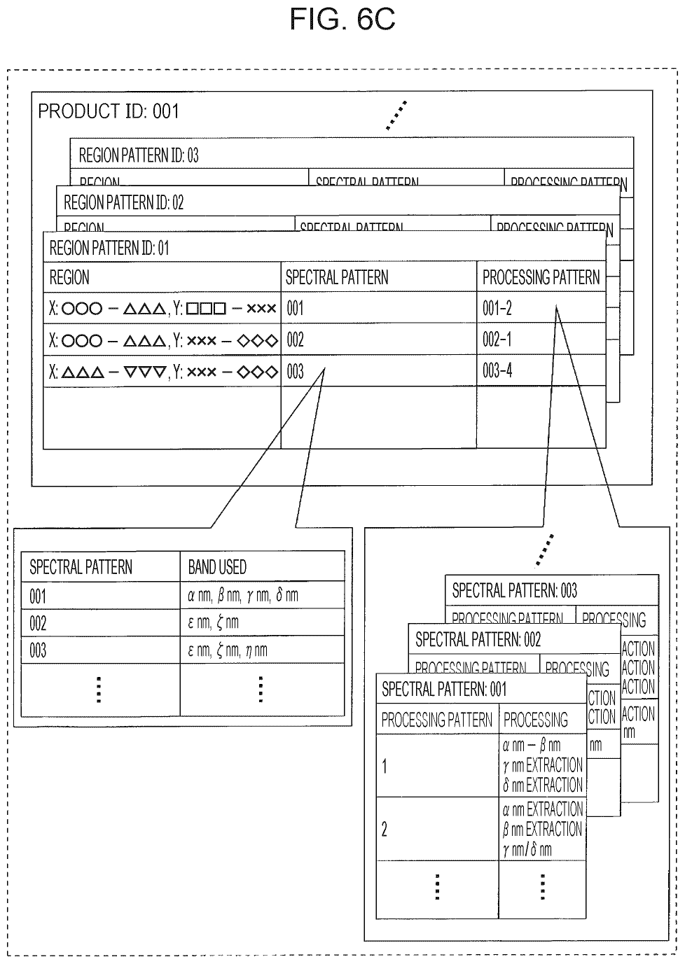

Next, with reference to FIGS. 6A to 6C, examples of reference data stored in the storage device 30 illustrated in FIG. 3A will be described. FIGS. 6A to 6C are diagrams schematically illustrating examples of reference data stored in the storage device 30 illustrated in FIG. 3A. Product IDs illustrated in FIGS. 6A to 6C are IDs for identifying the types of product. FIGS. 6A to 6C illustrate, as examples, three formats as formats of reference data.

First Format

As illustrated in FIG. 6A, the reference data includes, for each product ID, tables to which region pattern IDs are assigned in a respective manner. Each table includes region information, band information, and processing information directly associated with a corresponding region pattern ID. The region information includes information regarding the range of XY coordinates for defining a region. The X axis and the Y axis may be, for example, parallel to the horizontal direction and the vertical direction of an image in a respective manner, the image having a rectangular shape. An origin of XY coordinates may be, for example, the center of the image having a rectangular shape or may be any one of the four corners of the image. The band information includes information regarding at least one band used and corresponding to the region information. The number of bands used may be one or more. For example, “α nm, β nm, γ nm, δ nm” refers to use of these four bands among the bands included in the target wavelength range. “α nm” refers to a band having a constant wavelength width such as 5 nm or 10 nm. The same applies to “β nm”, “γ nm”, and “δ nm”.

“α nm” is a simplification of “(α±Δα) nm”, which should have originally been stated. α is a predetermined constant. Δα may be 2.5 or 5.

“β nm” is a simplification of “(β±Δβ) nm”, which should have originally been stated. β is a predetermined constant. Δβ may be 2.5 or 5.

“γ nm” is a simplification of “(γ±Δγ) nm”, which should have originally been stated. γ is a predetermined constant. Ay may be 2.5 or 5.

“δ nm” is a simplification of “(δ±Δδ) nm”, which should have originally been stated. δ is a predetermined constant. Δδ may be 2.5 or 5.

“ε nm” is a simplification of “(ε±Δε) nm”, which should have originally been stated. ε is a predetermined constant. Δε may be 2.5 or 5.

“ζ nm” is a simplification of “(ζ±Δζ) nm”, which should have originally been stated. ζ is a predetermined constant. Δζ may be 2.5 or 5.

“η nm” is a simplification of “(η±Δη) nm”, which should have originally been stated. η is a predetermined constant. Δη may be 2.5 or 5.

The processing information includes information regarding a processing method about the way in which partial image data for bands used are to be processed. “α nm extraction” and “β nm extraction” refer to extraction of partial image data for α nm and that for β nm, respectively. “γ nm/δ nm” refers to generation of processed image data, which is obtained by dividing pixel values of partial image data for γ nm by pixel values of partial image data for δ nm. The processed image data can be generated by performing addition, subtraction, multiplication, or division using pixel values of partial image data for the bands.

Second Format

As illustrated in FIG. 6B, the reference data includes, for each product ID, main tables to which region pattern IDs are assigned in a respective manner. Each main table includes region information and spectral pattern ID information directly associated with a corresponding region pattern ID. The reference data further includes a sub-table representing a relationship between spectral pattern IDs and bands used, and a sub-table representing a relationship between the spectral pattern IDs and processing methods. The balloons illustrated in FIG. 6B represent a correspondence relationship between information included in the main tables and the sub-tables. In a case where a spectral pattern ID is determined, bands used and processing methods are also determined.

Third Format

As illustrated in FIG. 6C, the reference data includes, for each product ID, main tables to which region pattern IDs are assigned in a respective manner. Each main table includes region information, spectral pattern ID information, and processing pattern ID information directly associated with a corresponding region pattern ID. The reference data further includes a sub-table representing a relationship between spectral pattern IDs and bands used and, for each spectral pattern ID, a sub-table representing a relationship between processing pattern IDs and processing methods. The balloons illustrated in FIG. 6C are substantially the same as those illustrated in FIG. 6B. The third format differs from the second format in that processing pattern IDs are present for one spectral pattern ID. The processing methods differ for each processing pattern ID. The third format is applied to a case where the processing methods differ for each object even when the same band or bands are used.

The reference data as illustrated in FIGS. 6A to 6C is prestored in the storage device 30 by the user. The user may generate reference data using, for example, the input apparatus 20 illustrated in FIG. 4B. The user inputs region information, band information, and processing information through the GUI displayed on the display device 24. The processing circuit 23 acquires data output from the image processing apparatus 24 and generates and outputs reference data. The processing circuit 40 stores, in the storage device 30, the reference data output from the input apparatus 20.

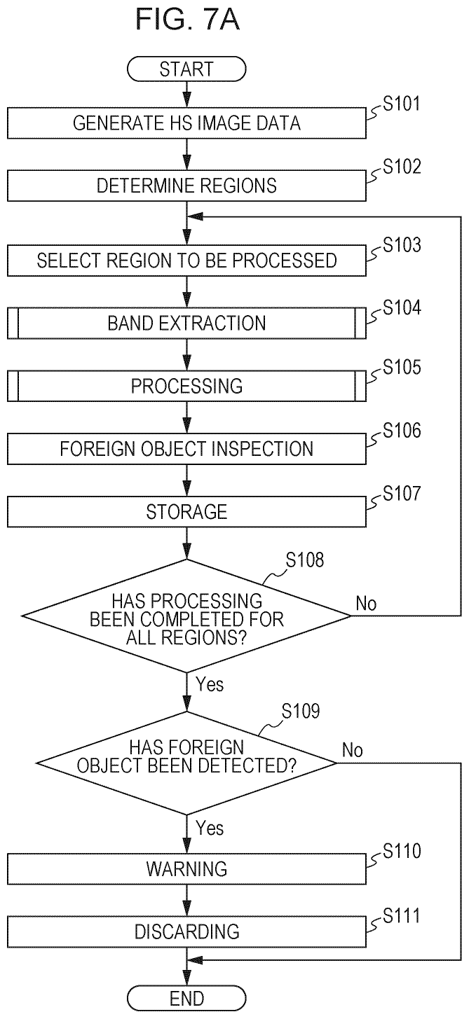

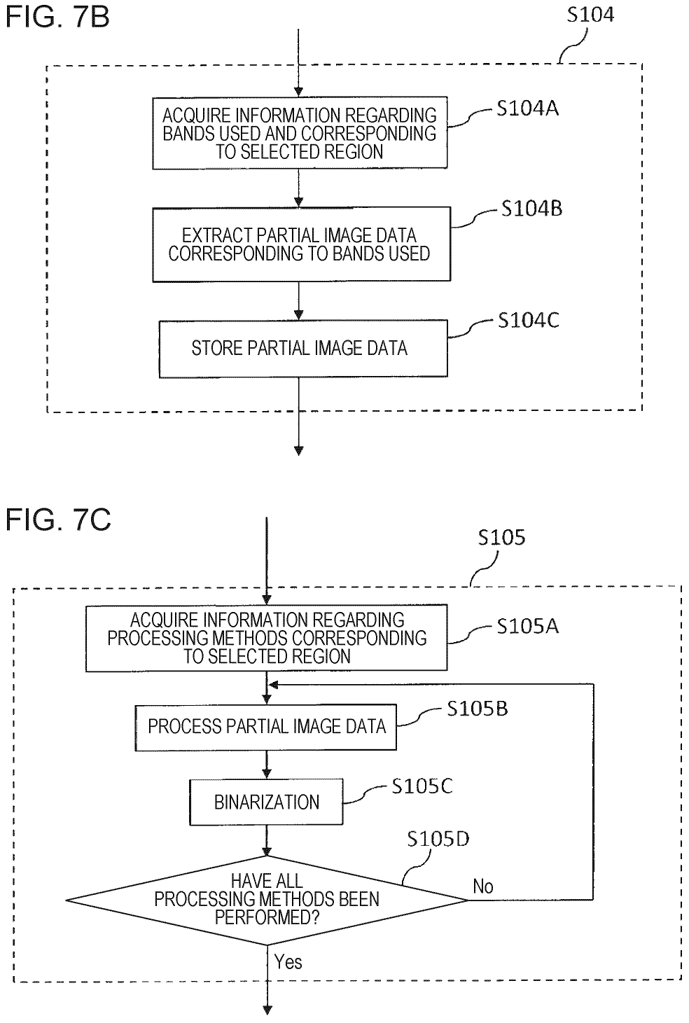

Next, with reference to FIGS. 7A to 7C, an example of an operation of the processing circuit 40 in foreign object inspection will be described. Before a foreign object inspection is performed, the user divides, using the input apparatus 20, an image of an object that is of the same type as an object to be inspected and on or in which a foreign object is not present into regions and specifies region content for each region. The processing circuit 40 stores, in the storage device 30, the region classification data output from the input apparatus 20. Before performing a foreign object inspection, the processing circuit 40 acquires reference data from the storage device 30 on the basis of the region classification data. A region pattern included in the acquired reference data matches a layout pattern of region content included in the region classification data.

FIG. 7A is a flow chart illustrating an example of an operation of the processing circuit 40 in foreign object inspection. The processing circuit 40 performs operations in Steps S101 to S111 illustrated in FIG. 7A. FIG. 7B is a flow chart illustrating an example of operations of the processing circuit 40 in Step S104 illustrated in FIG. 7A. FIG. 7C is a flow chart illustrating an example of operations of the processing circuit 40 in Step S105 illustrated in FIG. 7A. Note that, as long as there is no contradiction, the order of steps may be switched or a new step may be added between steps in the flow charts in this specification.

Step S101

The processing circuit 40 causes the imaging apparatus 10 to capture an image of an object. The imaging apparatus 10 generates and outputs hyperspectral image data of the object. “HS image data” illustrated in FIG. 7A refers to hyperspectral image data.

Step S102

The processing circuit 40 acquires the hyperspectral image data from the imaging apparatus 10 and acquires region classification data from the storage device 30. The processing circuit 40 determines, on the basis of the region classification data, regions in an image represented by the hyperspectral image data.

Step S103

The processing circuit 40 selects a region to be processed from the regions determined in Step S102.

Step S104

The processing circuit 40 performs operations in Steps S104A to S104C illustrated in FIG. 7B and extracts partial image data corresponding, in a respective manner, to bands used. The processing circuit 40 acquires, on the basis of the reference data, information regarding bands used and corresponding to the selected region (Step S104A). Next, the processing circuit 40 extracts, from the hyperspectral image data, partial image data corresponding, in a respective manner, to the bands used (Step S104B). Next, the processing circuit 40 stores, in the storage device 30, the extracted partial image data (Step S104C).

Step S105

The processing circuit 40 performs operations in Steps S105A to S105C illustrated in FIG. 7C to process the extracted partial image data. The processing circuit 40 acquires, on the basis of the reference data, information regarding processing methods corresponding to the selected region (Step S105A). Next, the processing circuit 40 processes the partial image data on the basis of the acquired processing methods (Step S105B). The processed partial image data may be, for example, processed image data obtained by processing extracted partial image data for a single band or extracted partial image data for bands. Next, the processing circuit 40 binarizes individual pixel values in the processed partial image data with respect to a constant value (Step S105C). Next, the processing circuit 40 determines whether all the processing methods included in the processing information have been performed (Step S105D). When Yes in Step S105D, the processing circuit 40 performs an operation in Step S106. When No in Step S105D, the processing circuit 40 performs the operation in Step S105B again.

Step S106

The processing circuit 40 inspects the selected region for presence of a foreign object on the basis of the binarization results in Step S105. For example, in a case where there is a portion having pixel values greater than or equal to a certain constant value or less than or equal to a certain constant value in an image represented by the processed partial image data, the processing circuit 40 can determine that a foreign object is present in the portion.

Step S107

The processing circuit 40 stores, in the storage device 30, data representing the inspection result.

Step S108

The processing circuit 40 determines whether processing has been completed for all the regions obtained as a result of division. When Yes in Step S108, the processing circuit 40 performs an operation in Step S109. When No in Step S108, the processing circuit 40 performs the operation in Step S103 again.

Step S109

The processing circuit 40 determines, on the basis of the data representing the inspection results stored in the storage device 30, whether a foreign object has been detected. When Yes in Step S109, the processing circuit 40 performs an operation in Step S110. When No in Step S109, the processing circuit 40 ends the operation.

Step S110

The processing circuit 40 causes the output apparatus 50 to output information regarding a warning. An output method is as described in the section where the output apparatus 50 illustrated in FIG. 3A is described.

Step S111

The processing circuit 40 causes the actuator 60 to discard an object on or in which a foreign object is detected. A disposal method is as described in the section where the actuator 60 illustrated in FIG. 3A is described.

In a case where objects 70 are transported in a sequential manner as illustrated in FIG. 3B, the processing circuit 40 performs the operations in Steps S101 to S111 on each of the objects 70. In a case where the type of object 70 is changed, before a foreign object inspection is performed, the user newly generates, using the input apparatus 20, region classification data for an object that is of the same type as an object to be inspected and on or in which a foreign object is not present. The processing circuit 40 causes the storage device 30 to update the stored region classification data to the new region classification data. Before performing a foreign object inspection, the processing circuit 40 updates the reference data on the basis of the new region classification data. After starting a foreign object inspection, the processing circuit 40 updates the regions in the image represented by the hyperspectral image data in Step S102, updates the information regarding the bands used and included in the band information in Step S104, and updates the information regarding the processing methods included in the processing information in Step S105.

In the first embodiment, foreign object inspection is performed using image data for some of the four or more bands included in the target wavelength range. The image data for some of the four or more bands can be acquired from the hyperspectral image data generated by a hyperspectral camera. Use of a light source that emits light in the near-infrared region other than the visible light region enables detection of a foreign object that is not easily visually detected.

In the first embodiment, processing methods are specified for each region obtained as a result of division. In a case where division into regions is not performed, even when a processing method is necessary for a certain region but not necessary for another region, the processing method needs to be performed on the entire region. In the first embodiment, there is no need to spend time performing such a processing method unnecessarily. Division into regions is effective in reducing a processing load. In the first embodiment, foreign object inspection can be performed at appropriate processing speed in in-line inspection.

### Example of First Embodiment

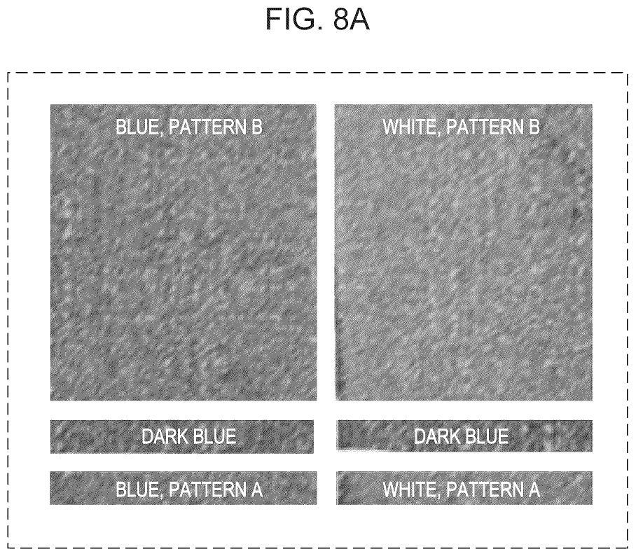

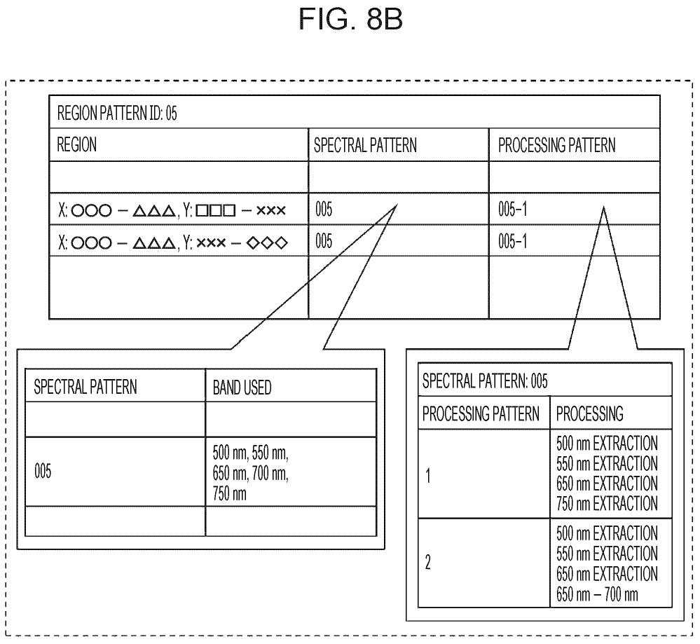

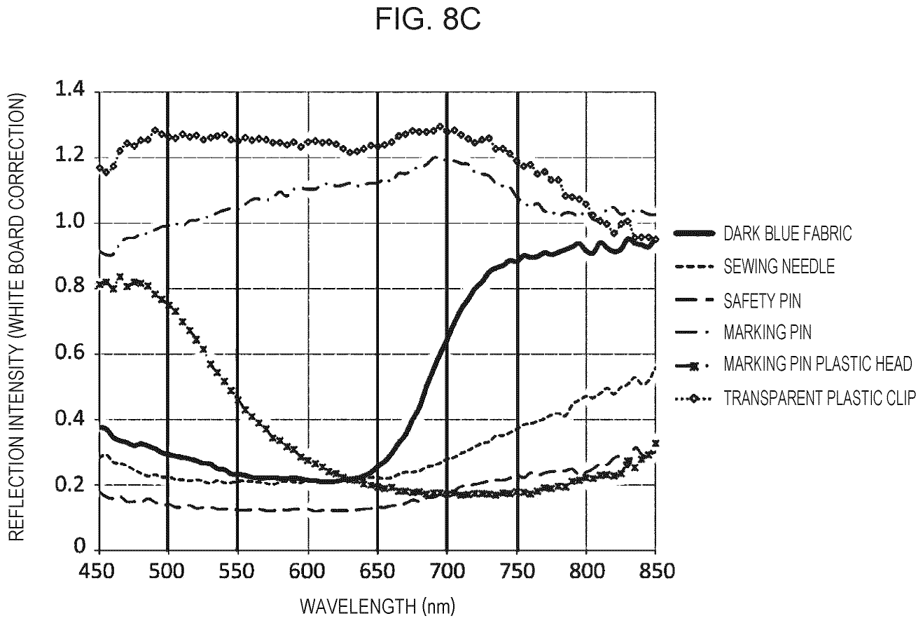

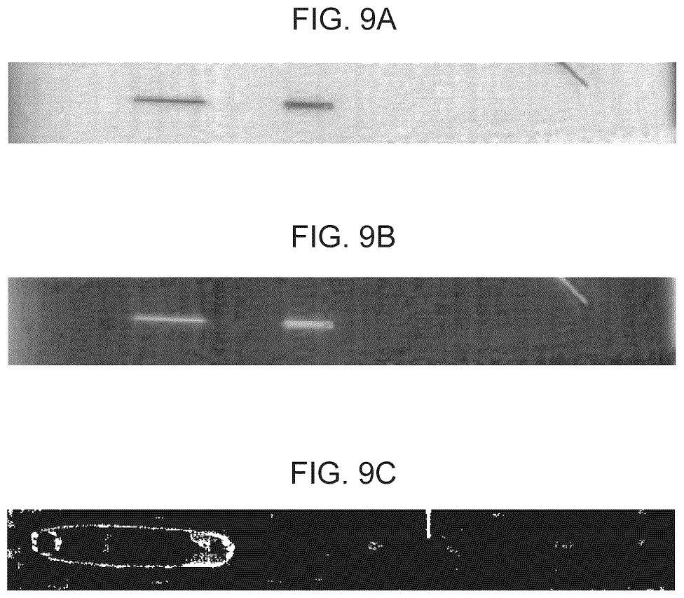

In the following, an example of the first embodiment will be described with reference to FIGS. 8A to 9C. An object in the example is a garment having colors and/or patterns among industrial products. FIG. 8A is a diagram illustrating a result obtained by the input apparatus 20 dividing an image of an object into regions. As illustrated in FIG. 8A, the object is divided into six regions. In the six regions, colors and/or patterns are specified such as “blue, pattern A”, “white, pattern A”, “dark blue”, “dark blue”, “blue, pattern B”, and “white, pattern B”. There are two regions classified into “dark blue”. The two regions are regions of a dark blue fabric included in a garment.

FIG. 8B is a diagram schematically illustrating reference data in the example. The reference data illustrated in FIG. 8B has the third format. The reference data illustrated in FIG. 8B illustrates information regarding “dark blue” for convenience' sake. A spectral pattern 005 is specified in two regions in the main table. For the spectral pattern 005 in a sub-table on the left, 500 nm, 550 nm, 650 nm, 700 nm, and 750 nm are specified as bands used. For a processing pattern 005-1 in a sub-table on the right, processing methods for extracting image data for 500 nm, 550 nm, 650 nm, and 750 nm are specified. For a processing pattern 005-2 in the sub-table on the right, processing methods for extracting image data for 500 nm, 550 nm, and 650 nm, and a processing method for generating processed image data obtained by subtracting pixel values of image data for 700 nm from pixel values of image data for 650 nm are specified.

FIG. 8C is a graph illustrating the reflection spectra of a dark blue fabric and possible foreign objects in a region classified into “dark blue”. The possible foreign objects may be sewing needles, marking pins, transparent plastic clips, safety pins, and marking pin plastic heads. Thick vertical lines illustrated in FIG. 8C represent bands used. The reflection spectra illustrated in FIG. 8C are the basis for the reference data illustrated in FIG. 8B.

In the processing pattern 500-1, image data for 500 nm, 550 nm, and 650 nm are extracted. In these bands, the reflection intensities of foreign objects that are shiny or have color tones other than black or dark blue are higher than that of the dark blue fabric. In a case where such a foreign object is present on a dark blue fabric, the foreign object will appear white, and the dark blue fabric other than the foreign object will appear black in images for these bands. The processing circuit 40 detects a foreign object as in the following, for example. The processing circuit 40 counts the number of white or gray pixels whose pixel values in image data are greater than or equal to a certain value. In a case where the counted number of pixels, or the ratio obtained by dividing the counted number of pixels by the total number of pixels in the “dark blue” region is greater than or equal to a certain value, the processing circuit 40 can determine that a foreign object has been detected. Alternatively, the processing circuit 40 may detect a foreign object using an algorithm such as machine learning. In a case where a hyperspectral image of an object on or in which a foreign object is not present is treated as learned training data, and a hyperspectral image of an object to be inspected is different from the training data, the processing circuit 40 can determine that a foreign object has been detected.

In the processing pattern 500-1, furthermore, image data for 750 nm is extracted. In images for 750 nm, the reflectance of a dark blue fabric is high in this band, and thus a “safety pin” and a “sewing needle” will appear black, and the dark blue fabric other than these items will appear white. In images for 750 nm, a “safety pin” and a “sewing needle”, which are not easily identified in images for 500 nm, 550 nm, and 650 nm, can be identified.

A processing pattern 500-2 includes the same processing methods as the processing pattern 500-1 and a different processing method from the processing pattern 500-1. The same processing methods as for the processing pattern 500-1 are to extract image data for 500 nm, 550 nm, and 650 nm. The different processing method from those for the processing pattern 500-1 is to generate processed image data obtained by subtracting pixel values of image data for 700 nm from pixel values of image data for 650 nm. In a processed image represented by the processed image data, a “safety pin” will appear white, and the dark blue fabric other than that will appear black.

The processing pattern 500-1 is used in a case where a halogen lamp is used as a light source for illuminating an object. Light emitted from a halogen lamp includes light in the near-infrared region. Thus, in foreign object inspection, image data for 750 nm can be used. In contrast, the processing pattern 500-2 is used in a case where a light-emitting diode (LED) is used as a light source for illuminating an object. Light emitted from an LED hardly includes light having wavelengths longer than 700 nm. Thus, the above-described processed image data is used.

The reflection spectra illustrated in FIG. 8C indicate that there are combinations of the dark blue fabric and foreign objects that are not easy to identify in foreign object inspection using a monochrome camera or an RGB camera. In contrast, in foreign object inspection using a hyperspectral camera, it can be seen that such foreign objects that are not easy to identify can be detected more accurately.

FIG. 9A is a diagram illustrating an image for 750 nm in a case where a sewing needle is present in a region classified into “dark blue”. In the image illustrated in FIG. 9A, the sewing needle appears black, and the dark blue fabric appears white. FIG. 9B is a diagram illustrating the black-and-white inverted image of FIG. 9A. In the image illustrated in FIG. 9B, the sewing needle appears white, and the dark blue fabric appears black. In a case where the black-and-white inverted image for 750 nm is used, similarly to as in the images for 500 nm, 550 nm, and 650 nm, the processing circuit 40 can determine, on the basis of the counted number of white or gray pixels, that a foreign object has been detected.

FIG. 9C is a diagram illustrating the above-described processed image in a case where a safety pin is present in a region classified into “dark blue”. In the image illustrated in FIG. 9C, the safety pin appears white, and the dark blue fabric appears black. Thus, as described above, the processing circuit 40 can determine, on the basis of the counted number of white or gray pixels, that a foreign object has been detected.

### SECOND EMBODIMENT

In an inspection system according to a second embodiment, a foreign object on or in an object is detected using a hyperspectral camera using a compressed-sensing technology. The summary of a foreign object detection method according to the second embodiment is as follows. Compressed image data of an object to be inspected is acquired. An image represented by the compressed image data is divided into regions. For each of the regions, partial image data for at least one band among four or more bands included in a target wavelength range is reconstructed from the compressed image data. On the basis of the reconstructed partial image data, a detection operation for detecting a foreign object on or in the object is performed for each region.

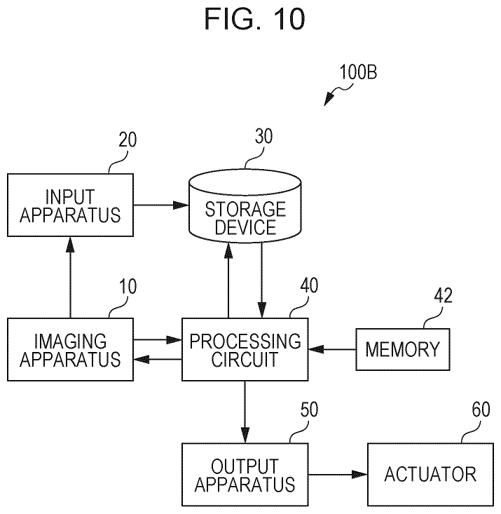

In the following, with reference to FIG. 10, the inspection system according to the second embodiment will be described. FIG. 10 is a block diagram schematically illustrating the inspection system according to the second embodiment, which is an exemplary embodiment of the present disclosure. An inspection system 100B illustrated in FIG. 10 includes an imaging apparatus 10, an input apparatus 20, a storage device 30, a processing circuit 40, a memory 42, an output apparatus 50, and an actuator 60. The following mainly describes the points in which the inspection system 100B according to the second embodiment differs from the inspection system 100A according to the first embodiment.

The imaging apparatus 10 functions as a hyperspectral camera that generates compressed image data of an object through imaging using a compressed-sensing technology and outputs the compressed image data. The imaging apparatus 10 may have, for example, an optical system, a filter array, and an image sensor positioned in this order along an optical path of reflected light from the object or transmitted light through the object. The optical system forms an image on a photodetecting surface of the image sensor. The filter array modulates the intensity of incident light on a filter basis and emits the resulting light. The image sensor detects light that has passed through the filter array.

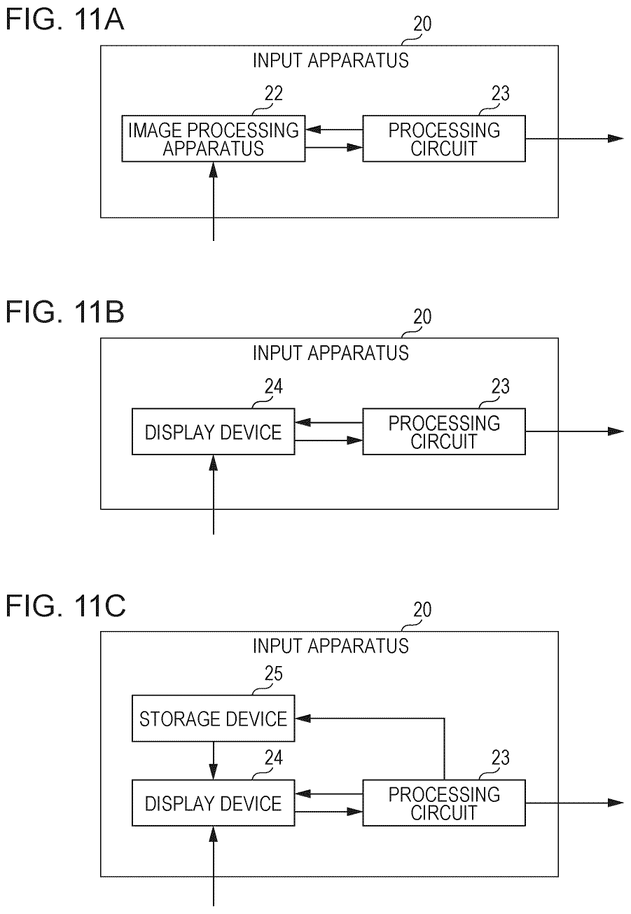

The input apparatus 20 acquires compressed image data output from the image processing apparatus 10, generates region classification data on the basis of the compressed image data, and outputs the region classification data. FIGS. 11A to 11C are block diagrams schematically illustrating examples of the input apparatus 20 illustrated in FIG. 10. The input apparatus 20 illustrated in FIGS. 11A to 11C differs from the input apparatus 20 illustrated in FIGS. 4A to 4C in that the input apparatus 20 does not have a pre-recording camera 21. The input apparatus 20 generates region classification data on the basis of not image data generated by the pre-recording camera 21 but the compressed image data output from the imaging apparatus 10, and outputs the region classification data. Generation of region classification data in the input apparatus 20 illustrated in FIGS. 11A to 11C is as described in the section where the input apparatus 20 illustrated in FIGS. 4A to 4C is described.

Note that the input apparatus 20 may have a configuration illustrated in any one of FIGS. 4A to 4C and may generate region classification data on the basis of image data generated by the pre-recording camera 21 and output the region classification data.

The storage device 30 stores region classification data output from the input apparatus 20, a filter array reconstruction table to be used in a compressed-sensing technology, reference data to be used in foreign object inspection, and data representing a foreign object inspection result for each region. The reconstruction table is a reconstruction table for all the regions or a reconstruction table for each of the regions obtained through division. In the following description, the reconstruction table for all the regions will be referred to as a “full-reconstruction table”, and the reconstruction table for each of the regions obtained through division” will be referred to as a “region-specific reconstruction table”. The reference data includes a table representing a relationship between reconstructed bands and processing methods for each of the regions.

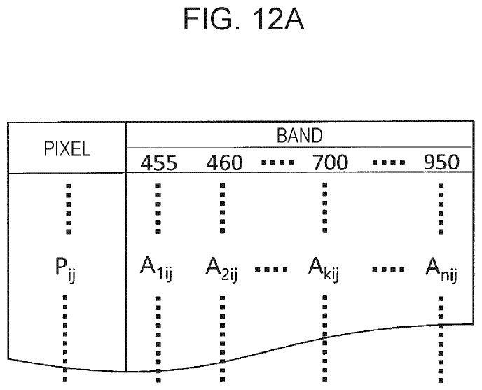

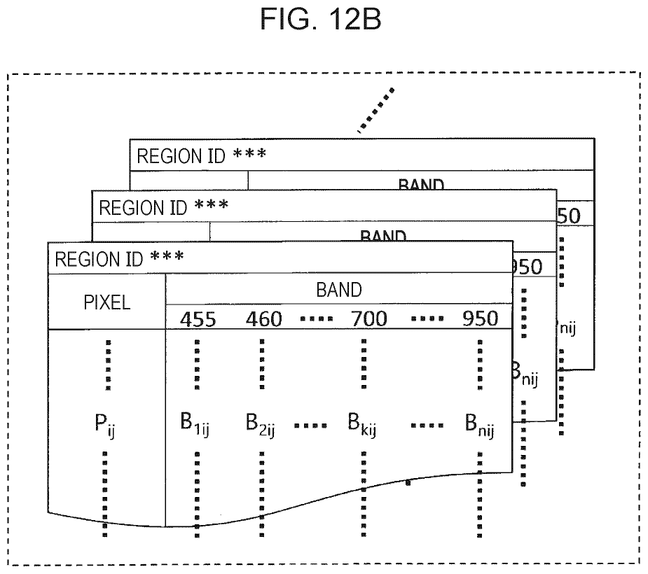

FIG. 12A is a diagram schematically illustrating an example of a full-reconstruction table. “Pᵢⱼ” illustrated in FIG. 12A represents the position of a pixel. “Aₖᵢⱼ” illustrated in FIG. 12A represents a luminous transmittance at the pixel Pᵢⱼ in the k-th band. k=1, 2, . . . , n. FIG. 12B is a diagram schematically illustrating an example of region-specific reconstruction tables. As illustrated in FIG. 12B, region IDs are assigned to, in a respective manner, regions obtained as a result of division. “Pᵢⱼ” illustrated in FIG. 12B represents the position of a pixel for each region. “Bₖᵢⱼ” illustrated in FIG. 12B represents a luminous transmittance at the pixel Pᵢⱼ in the k-th band for each region. k=1, 2, . . . , n.

By using the region-specific reconstruction tables corresponding to the bands used, partial image data for the bands used can be reconstructed in a selective manner for each region from the compressed image data. Thus, the computing load on the processing circuit 40 can be reduced. Details of this selective reconstruction method are disclosed in WO2021/192891A1. After reconstructing, in a selective manner and using the region-specific reconstruction tables, the partial image data for the bands used, the processing circuit 40 can perform foreign object inspection on the basis of the sub-table on the right in FIG. 6B or the sub-table on the right in FIG. 6C. The sub-table on the right in FIG. 6B illustrates a relationship between spectral pattern IDs and processing methods in the second format. The sub-table on the right in FIG. 6C illustrates, for each spectral pattern ID, a relationship between processing pattern IDs and processing methods in the third format.

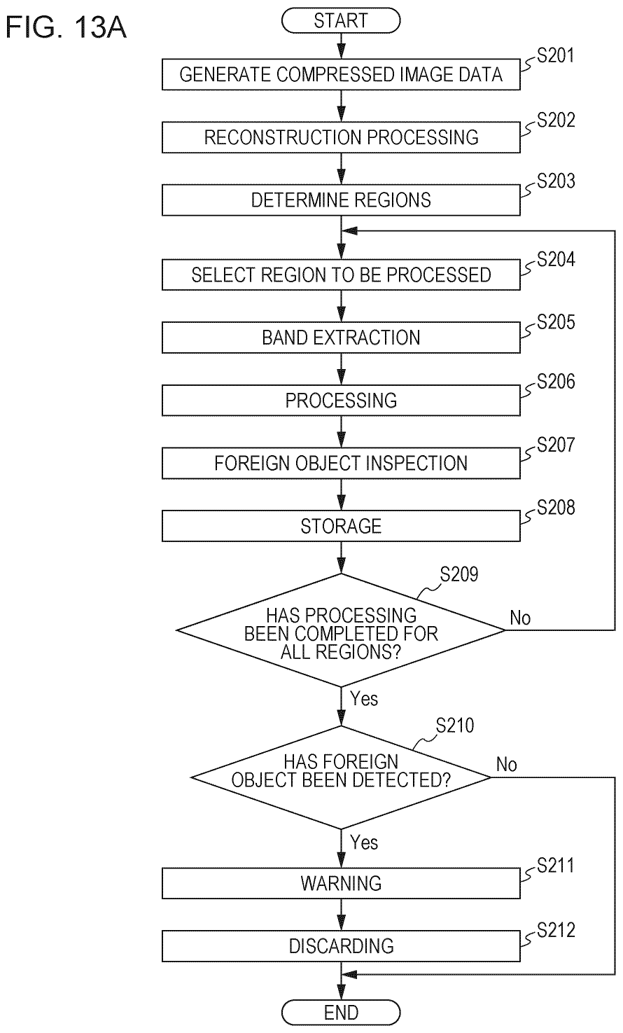

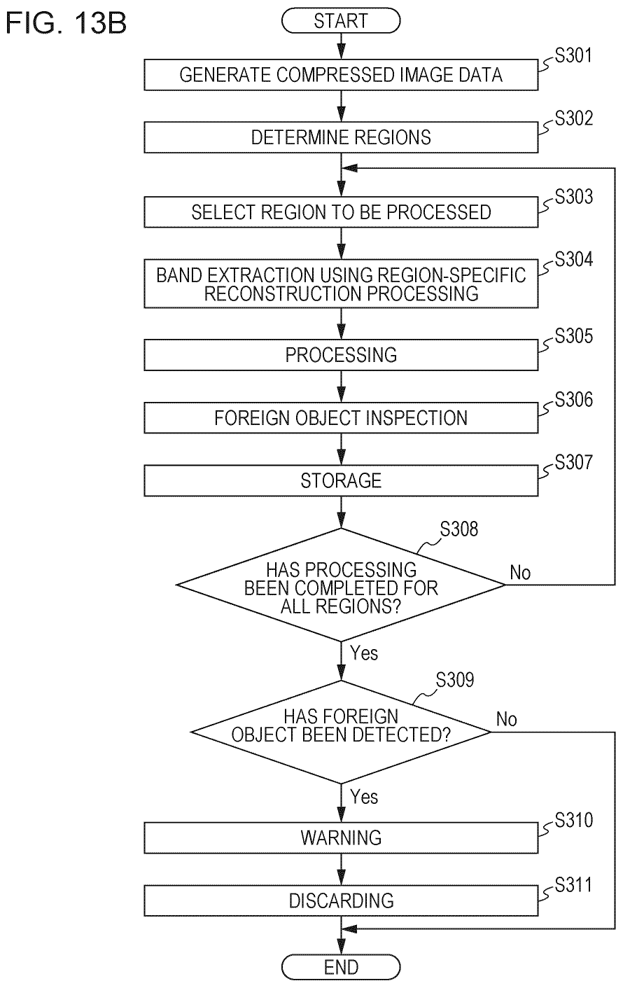

Next, with reference to FIG. 13A, an example of an operation of the processing circuit 40 in foreign object inspection using a full-reconstruction table will be described. Before performing a foreign object inspection, the processing circuit 40 causes the storage device 30 to store region classification data output from the input apparatus 20, and the processing circuit 40 acquires reference data from the storage device 30 on the basis of region classification data. These operations are as stated in the first embodiment.

FIG. 13A is a flow chart illustrating an example of an operation of the processing circuit 40 in foreign object inspection using a full-reconstruction table. The processing circuit 40 performs operations in Steps S201 to S212 illustrated in FIG. 13A.

Step S201

The processing circuit 40 causes the imaging apparatus 10 to capture an image of an object. The imaging apparatus 10 generates and outputs compressed image data of the object.

Step S202

The processing circuit 40 acquires the compressed image data from the imaging apparatus 10 and acquires a full-reconstruction table from the storage device 30. The processing circuit 40 reconstructs, using the full-reconstruction table, hyperspectral image data from the compressed image data.

Step S203

The processing circuit 40 acquires region classification data from the storage device 30. The processing circuit 40 determines, on the basis of the region classification data, regions in an image represented by the hyperspectral image data.

Steps S204 to S212

Operations in Steps S204 to S212 are the same as those in Steps S103 to S111 illustrated in FIG. 7A.

Next, an example of an operation of the processing circuit 40 in foreign object inspection using region-specific reconstruction tables will be described with reference to FIG. 13B. Before performing a foreign object inspection, the processing circuit 40 causes the storage device 30 to store region classification data output from the input apparatus 20, and the processing circuit 40 acquires reference data from the storage device 30 on the basis of region classification data. These operations are as stated in the first embodiment. In addition, before performing a foreign object inspection, the processing circuit 40 generates region-specific reconstruction tables on the basis of the region classification data and the full-reconstruction table acquired from the storage device 30.

FIG. 13B is a flow chart illustrating an example of an operation of the processing circuit 40 in foreign object inspection using region-specific reconstruction tables. The processing circuit 40 performs operations in Steps S301 to S311 illustrated in FIG. 13B.

Step S301

The processing circuit 40 causes the imaging apparatus 10 to capture an image of an object. The imaging apparatus 10 generates and outputs compressed image data of the object.

Step S302

The processing circuit 40 acquires the compressed image data from the imaging apparatus 10 and acquires region classification data from the storage device 30. The processing circuit 40 determines, on the basis of the region classification data, regions in an image represented by the compressed image data.

Step S303

The processing circuit 40 selects a region to be processed from the regions determined in Step S302.

Step S304

The processing circuit 40 acquires region-specific reconstruction data from the storage device 30. The processing circuit 40 reconstructs, using region-specific reconstruction tables, partial image data for bands used in the region selected in Step S303 from the compressed image data in a selective manner.

Note that the processing circuit 40 may reconstruct, using the region-specific reconstruction tables, partial image data for all the bands in the region selected in Step S303 from the compressed image data. The processing circuit 40 extracts, from the partial image data for all the bands, partial image data for bands used.

Steps S305 to S311

Operations in Steps S305 to S311 are the same as those in Steps S105 to S111 illustrated in FIG. 7A.

In the second embodiment, an image can be divided into regions by acquiring a region specification input for compressed image data from the user, and partial image data for bands used for each region can be reconstructed in a selective manner from the compressed image data. In the second embodiment, compared with a configuration in which compressed image data is not used and an image is not divided into regions, the number of times processing is performed and the amount of data stored temporarily can be significantly reduced. In the second embodiment, foreign object inspection can be performed at appropriate processing speed in in-line inspection.

### Example of Second Embodiment

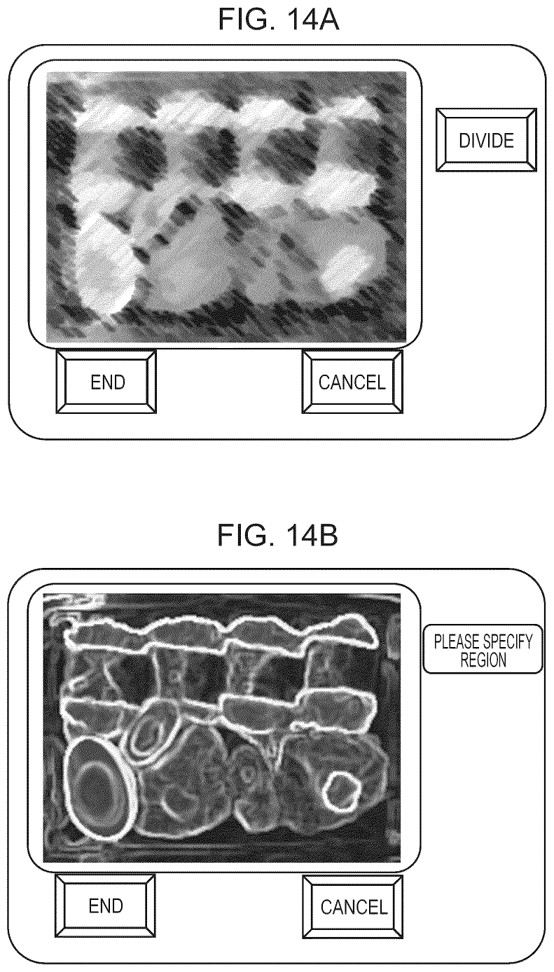

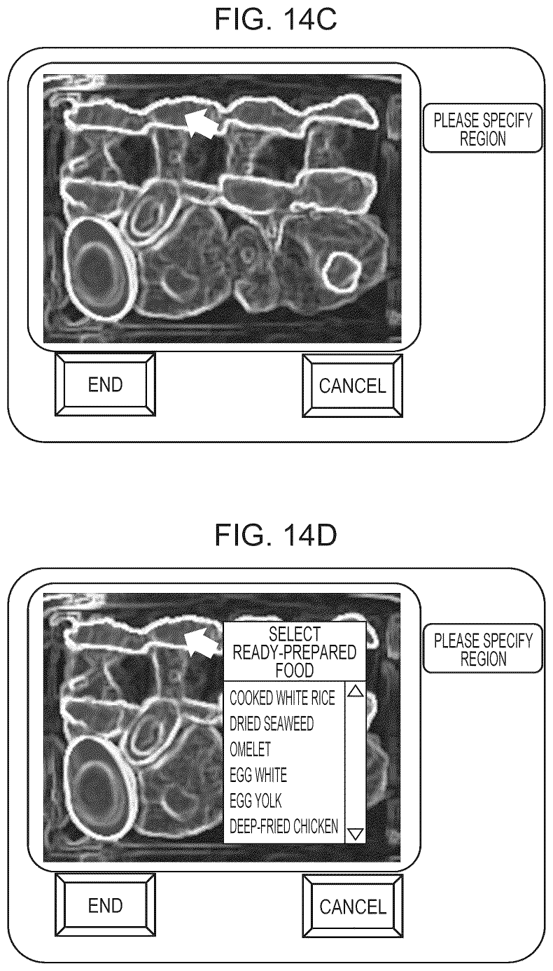

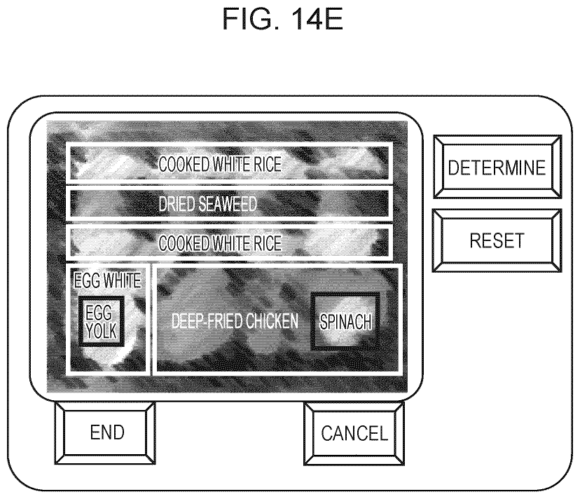

In the following, with reference to FIGS. 14A to 17C, an example of the second embodiment will be described. Among processed food products, an object in the example is a boxed meal including ready-prepared foods and food materials therein. In the example, a foreign object inspection was performed using region-specific reconstruction tables.

FIGS. 14A to 14E are diagrams for describing a procedure in which, using the input apparatus 20 illustrated in FIG. 11B, a compressed image of a boxed meal is divided into regions, and region contents are specified.

As illustrated in FIG. 14A, a GUI displayed on the display device 24 displays a compressed image captured by the imaging apparatus 10 and a divide button. The user starts dividing the compressed image into regions by selecting the divide button. The GUI further displays a cancel button and an end button. The user may cancel a previous selection by selecting the cancel button or end an input operation by selecting the end button. The GUIs illustrated in FIGS. 14B to 14E also display the cancel button and the end button. Displayed buttons may include buttons other than the divide button, the cancel button, and the end button. Moreover, in addition to these functions, the buttons may have a function through which a region in the image is specified.

As illustrated in FIG. 14B, the GUI displays the compressed image that is divided into regions and a region specification button. The user selects the region specification button.

The regions described above may be stored in advance as a boxed-meal content classification pattern. Moreover, the individual regions may be obtained through division performed in accordance with pixel values or luminance of the compressed image. Division based on pixel values or luminance into regions is performed, for example, through clustering. For example, closed regions are generated on the basis of an edge extraction result of the compressed image, and division regions are determined using, for example, the dynamic contour method. The compressed image may be divided into regions using methods other than this method.

As illustrated in FIG. 14C, the GUI displays a cursor, which is represented as a white arrow, as a pointing device on the compressed image that is divided into regions. The user specifies a region using the cursor.

As illustrated in FIG. 14D, the GUI displays, for the specified region, a list of food materials and ready-prepared foods. The user selects, from the list, a food material or a ready-prepared food present in the specified region. In this manner, the user specifies a food material or a ready-prepared food for each region.

As illustrated in FIG. 14E, the GUI displays the compressed image in which a food material or a ready-prepared food is specified for each region, a determine button, and a reset button. The user determines, by selecting the determine button, specification of a food material or a ready-prepared food for each region. The user may redo, by selecting the reset button, specification of a food material or a ready-prepared food for each region. Note that a compressed image as illustrated in FIG. 14E in which a food material or a ready-prepared food is specified for each region may be generated by allocating a classification pattern serving as the layout of contents of a predetermined boxed meal to regions obtained through image processing.

Specification of a food material or a ready-prepared food for each region using a GUI is useful in a case where boxed meals having the same kinds of food material and ready-prepared food but at different positions are to be newly inspected in food processing plants. In this case, before performing a foreign object inspection, the processing circuit 40 updates the region-specific reconstruction tables on the basis of the newly generated region classification data.

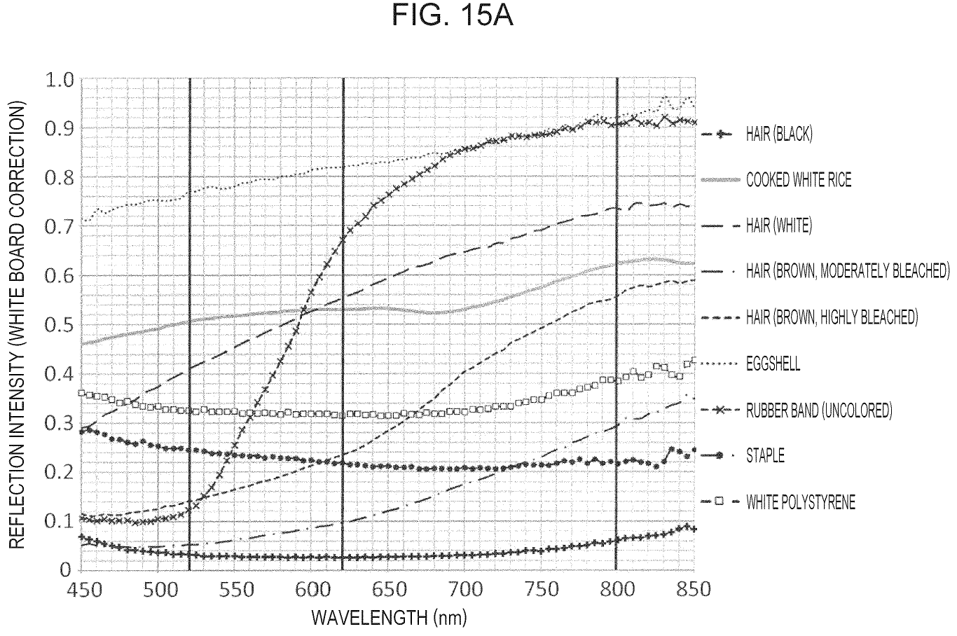

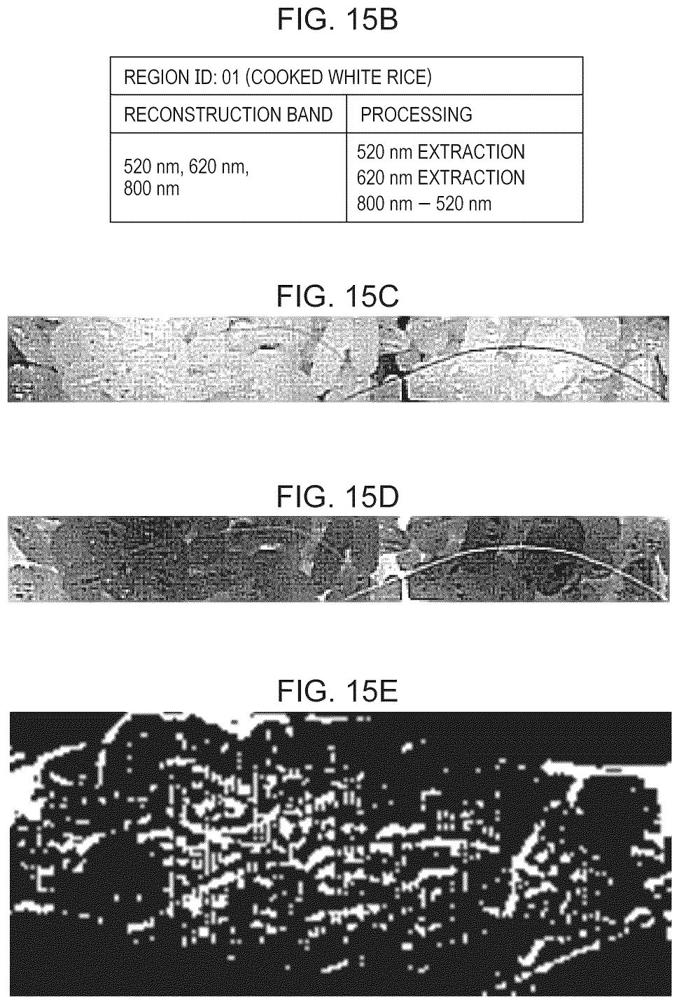

Next, with reference to FIGS. 15A to 15E, foreign object inspection in a region classified into “cooked white rice” among the regions illustrated in FIG. 14E will be described. FIG. 15A is a graph illustrating the reflection spectra of “cooked white rice” and possible foreign objects in a region classified into “cooked white rice”. The foreign objects are hairs (black hairs), hairs (white hairs), hairs (brown hairs that are moderately bleached), hairs (brown hairs that are highly bleached), pieces of eggshell, rubber bands (uncolored), staples, and pieces of white polystyrene. The reflection spectrum of “cooked white rice” does not depend much on wavelength, and the reflection intensity of “cooked white rice” is around 0.5. The reflection intensity of eggshell is higher than that of “cooked white rice” in every band in the target wavelength range. Thus, a piece of eggshell appears lighter than “cooked white rice” in images for any band. The reflection intensities of some of the foreign objects are lower than that of “cooked white rice” in every band in the target wavelength range. Such foreign objects appear darker than “cooked white rice” in images for any band. Among the reflection spectra of the foreign objects, the reflection spectrum of hair (white) is close to that of “cooked white rice”. Thus, the difference between a hair (a white hair) and “cooked white rice” is not clear in images for a single band, so that it is not easy to detect a hair (a white hair).

FIG. 15B is a diagram schematically illustrating, for a region classified into “cooked white rice”, a table representing a relationship between reconstruction bands and processing methods. The reconstruction bands are 520 nm, 620 nm, and 800 nm. Thick vertical lines illustrated in FIG. 15A represent these reconstruction bands. In the table illustrated in FIG. 15B, processing methods for extracting image data for 520 nm and 620 nm, and a processing method for generating processed image data by subtracting pixel values of image data for 520 nm from pixel values of image data for 800 nm are specified.

Image data for 620 nm is used to detect a foreign object such as a piece of eggshell, which appears lighter than “cooked white rice”. Image data for 520 nm is used to detect a foreign object that appears darker than “cooked white rice”. The above-described processed image data is used to detect a hair (a white hair).

FIG. 15C is a diagram illustrating an image for 520 nm in a case where a hair (a black hair) is present in a region classified into “cooked white rice”. In the image illustrated in FIG. 15C, a hair (a black hair) appears as a black line, and “cooked white rice” appears white. FIG. 15D is a diagram illustrating the black-and-white inverted image of FIG. 15C. In the image illustrated in FIG. 15D, the hair (the black hair) appears as a white line, and the “cooked white rice” appears black. As described above, the processing circuit 40 can determine, on the basis of the counted number of white or gray pixels, that a foreign object has been detected. By considering that a foreign object is a hair, the processing circuit 40 counts pixels that form a line among white or gray pixels. Alternatively, the processing circuit 40 may detect a foreign object using an algorithm such as machine learning.

FIG. 15E is a diagram illustrating a processed image in a case where a hair (a white hair) is present in a region classified into “cooked white rice”. In the image illustrated in FIG. 15E, the hair (the white hair) appears as a white line, and “cooked white rice” appears black. As described above, the processing circuit 40 can determine, on the basis of the counted number of white or gray pixels, that a foreign object has been detected. Since the spectrum of “cooked white rice” and that of a hair (a white hair) are similar to each other, it is not easy to identify a hair (a white hair) in images for any band. In contrast, a hair (a white hair) can be identified in processed images.

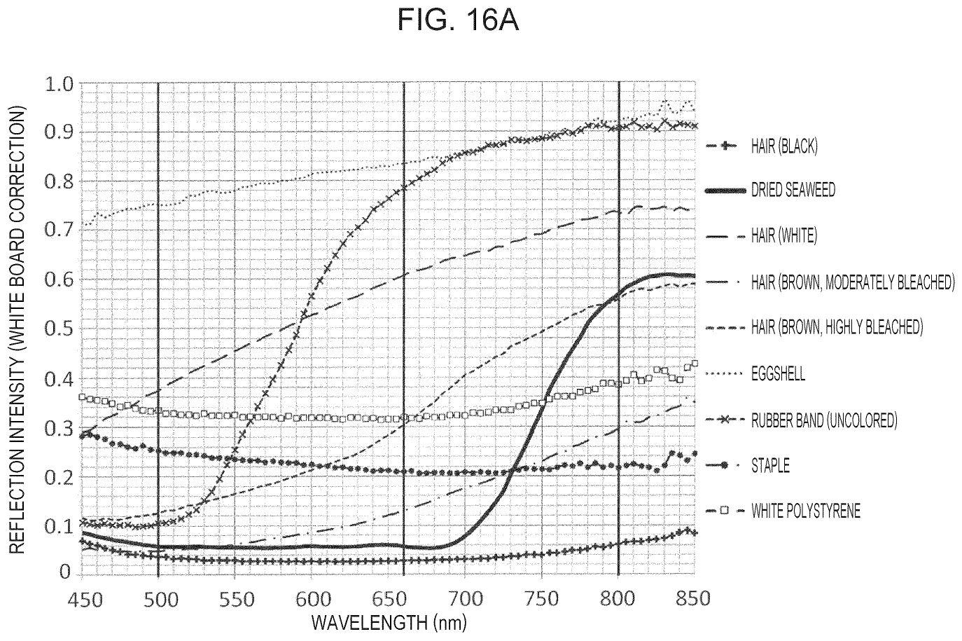

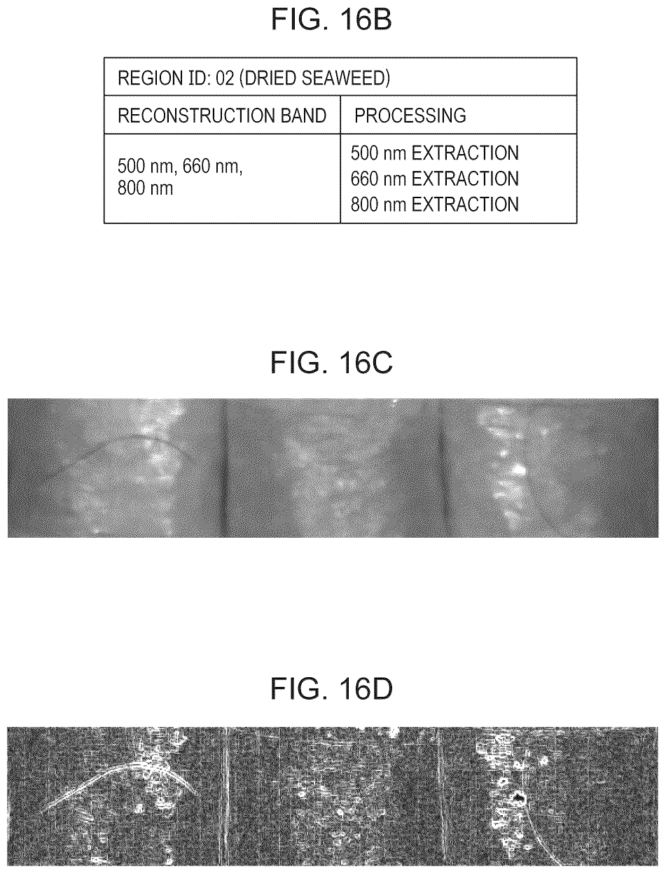

Next, with reference to FIGS. 16A to 16D, foreign object inspection in a region classified into “dried seaweed” among the regions illustrated in FIG. 14E will be described. The region classified into “dried seaweed” is positioned between two regions classified into “cooked white rice”. FIG. 16A is a graph illustrating the reflection spectra of “dried seaweed” and possible foreign objects in a region classified into “dried seaweed”. Regarding the reflection spectrum of “dried seaweed”, the reflection intensity of “dried seaweed” is low in a visible light region greater than or equal to 450 nm and less than or equal to 700 nm. In images for bands included in the visible light region, “dried seaweed” appears black. In contrast, the reflection intensity of “dried seaweed” increases as wavelength exceeds 700 nm and is equivalent to that of “cooked white rice” at a wavelength of 800 nm. In images for 800 nm, “dried seaweed” appears white. Thus, images for 800 nm may be used to detect black or dark-color foreign objects. Images for any band included in the visible light region may be used to detect foreign objects having color tones other than black or dark colors.

FIG. 16B is a diagram schematically illustrating, for a region classified into “dried seaweed”, a table representing a relationship between reconstruction bands and processing methods. The reconstruction bands are 500 nm, 660 nm, and 800 nm. Thick vertical lines illustrated in FIG. 16A represent these reconstruction bands. In the table illustrated in FIG. 16B, processing methods for extracting image data for 500 nm, 660 nm, and 800 nm are specified. Image data for these bands are used to detect black or dark-color foreign objects.

The image data for 500 nm is advantageous to detect a hair (a white hair) as illustrated in FIG. 16A. The image data for 660 nm is advantageous to detect a hair (a brown hair that is highly bleached) and a rubber band as illustrated in FIG. 16A. The image data for 800 nm is advantageous to detect a hair (a black hair) as illustrated in FIG. 16A.

FIG. 16C is a diagram illustrating an image for 800 nm in a case where a hair (a black hair) is present in a region classified into “dried seaweed”. In the image illustrated in FIG. 16C, the hair (the black hair) appears as a black line, and “dried seaweed” appears gray. FIG. 16D is a diagram illustrating the black-and-white inverted image of FIG. 16C. In the image illustrated in FIG. 16D, the hair (the black hair) appears as a white line. As described above, the processing circuit 40 can determine, on the basis of the counted number of white or gray pixels, that a foreign object has been detected.

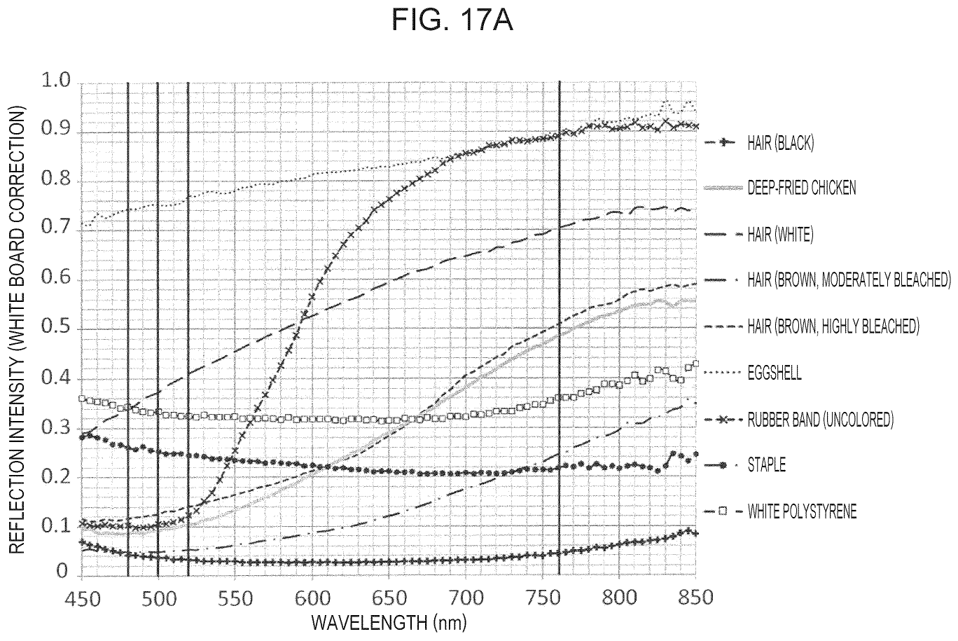

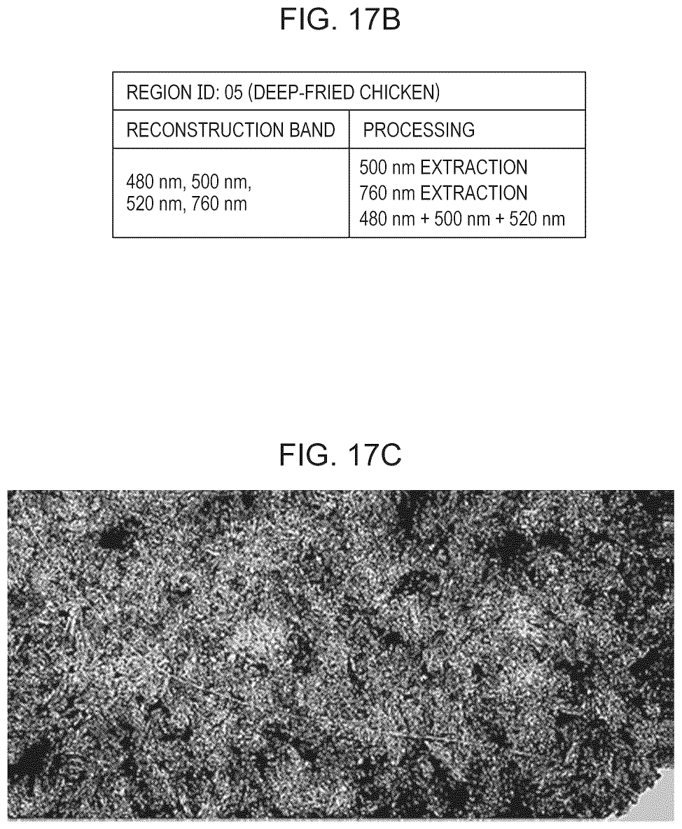

Next, with reference to FIGS. 17A to 17C, foreign object inspection in a region classified into “deep-fried chicken” among the regions illustrated in FIG. 14E will be described. FIG. 17A is a graph illustrating the reflection spectra of “deep-fried chicken” and possible foreign objects in a region classified into “deep-fried chicken”. Regarding the reflection spectrum of “deep-fried chicken”, the reflection intensity of “deep-fried chicken” increases from the short wavelength side to the long wavelength side. That is, “deep-fried chicken” appears black in images for bands on the short wavelength side and appears white or gray in images for bands on the long wavelength side. Images for the bands on the short wavelength side are used to detect white or near-white color foreign objects. Images for the bands on the long wavelength side are used to detect black or dark-color foreign objects. Among the reflection spectra of the foreign objects, the reflection spectrum of hair (brown, highly bleached) is substantially the same as that of “deep-fried chicken”. Thus, the difference between a hair (a brown hair that is highly bleached) and “cooked white rice” is not clear in images for a single band, so that it is not easy to detect a hair (a brown hair that is highly bleached).

FIG. 17B is a diagram schematically illustrating, for a region classified into “deep-fried chicken”, a table representing a relationship between reconstruction bands and processing methods. The reconstruction bands are 480 nm, 500 nm, 520 nm, and 760 nm. Thick vertical lines illustrated in FIG. 17A represent these reconstruction bands. In the table illustrated in FIG. 17B, processing methods for extracting image data for 500 nm and 760 nm, and a processing method for generating processed image data by adding pixel values of image data for 480 nm, 500 nm, and 520 nm to each other are specified.

The image data for 500 nm is used to detect white or near-white color foreign objects. The image data for 760 nm is used to detect black or dark-color foreign objects. The above-described processed image data is used to detect a hair (a brown hair that is highly bleached).

FIG. 17C is a diagram illustrating the above-described processed image in a case where a hair (a brown hair that is highly bleached) is present in a region classified into “deep-fried chicken”. In the image illustrated in FIG. 17C, the hair (the brown hair that is highly bleached) appears as a white line. As described above, the processing circuit 40 can determine, on the basis of the counted number of white or gray pixels, that a foreign object has been detected.

### First Example of Another Embodiment

A method according to an aspect of the present disclosure may be as follows:

A method comprising

(a) receiving an image, an imaging apparatus imaging a subject to generate the image, a filter array being provided between the subject and the imaging apparatus, the filter array including filters arranged two-dimensionally, light transmission characteristics of the filters being different from each other;

(b) calculating, on the basis of the image,

first pixel values of first pixels included in a first region included in a first image corresponding to light of a first wavelength band from the subject,

second pixel values of second pixels included in a second region included in a second image corresponding to light of a second wavelength band from the subject,

third pixel values of third pixels included in a third region included in a third image corresponding to light of a third wavelength band from the subject, and

fourth pixel values of fourth pixels included in a fourth region included in a fourth image corresponding to light of a fourth wavelength band from the subject,

the first region and the second region corresponding to a first portion of the subject,

the third region and the fourth region corresponding to a second portion of the subject,

pixel values of pixels included in a region other than the first region and included in the first image not being calculated,

pixel values of pixels included in a region other than the second region and included in the second image not being calculated,

pixel values of pixels included in a region other than the third region and included in the third image not being calculated,

pixel values of pixels included in a region other than the fourth region and included in the fourth image not being calculated;

(c) determining, on the basis of the first pixel values and the second pixel values, whether the first portion includes one or more first foreign objects; and

(d) determining, on the basis of the third pixel values and the fourth pixel values, whether the second portion includes one or more second foreign objects.

The following describes the above-described method.

The method may be used in a production line. For example, the method may be used in an inspection process as to whether a foreign object is present in a produced boxed meal (that is, an object 70) (see FIG. 3B).

The produced boxed meal includes a container and food materials. In the production process up to the inspection process, the food materials are individually arranged in predetermined regions in the container.

The processing circuit 40 receives an image output from the image sensor included in the imaging apparatus 10, that is, a compressed image (see FIG. 10). Note that the image sensor images the subject (for example, the produced boxed meal) to generate an image. The filter array 80, which includes filters that are two-dimensionally arranged, is provided between the subject and the image sensor. The filters have different light transmission characteristics of the filters are different from each other (see FIGS. 2A to 2C).

Pixel values of pixels included in the compressed image may be expressed as

$$[ \begin{matrix}P ( {g}_{11} ) & ⋯ & P ( {g}_{1 n} ) \\ ⋮ & ⋱ & ⋮ \\ P ( {g}_{m 1} ) & ⋯ & P ( {g}_{mn} )\end{matrix} ] \qquad ( 3 )$$

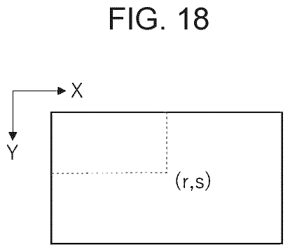

P(gᵣₛ) is a pixel value of a pixel gᵣₛ included in the compressed image. r=1 to m, and s=1 to n. The pixel gᵣₛ is positioned at coordinates (r, s) in the compressed image. FIG. 18 illustrates coordinate axes and an example of coordinates.

Data g of the compressed image may be expressed as

g=(P(g₁₁) . . . P(g₁ₙ) . . . P(gₘ₁) . . . P(gₘₙ))^{T}.

An image 12Wₖ (k=1 to i) corresponding to a wavelength band Wₖ may be considered to have image data fₖ. Pixel values of pixels included in the image 12Wₖ may be expressed as

$$[ \begin{matrix}P ( {f}_{k 11} ) & ⋯ & P ( {f}_{k 1 n} ) \\ ⋮ & ⋱ & ⋮ \\ P ( {f}_{km 1} ) & ⋯ & P ( {f}_{kmn} )\end{matrix} ] \qquad ( 4 )$$

P(f_{k rs}) is a pixel value of a pixel f_{k rs} included in the image 12Wₖ (r=1 to m, s=1 to n). The pixel f_{k rs} is positioned at coordinates (r, s) in the image 12Wₖ.

The image data fₖ of the image 12Wₖ may be expressed as

fₖ=(P(f_{k 11}) . . . P(f_{k 1n}) . . . P(f_{k m1}) . . . P(f_{k mn}))^{T}.

A pixel value P(f_{p rs}) included in image data fₚ and a pixel value P(f_{q rs}) included in image data f_{q} are pixel values at the same position of the subject.

Eq. (1) can be expressed as follows.

$$g = Hf = H [ \begin{matrix}{f}_{1} \\ ⋮ \\ {f}_{i}\end{matrix} ] \qquad ( 5 )$$

g is a matrix having m×n rows and one column, f is a matrix having m×n×i rows and one column, and H is a matrix having m×n rows and m×n×i columns.

The processing circuit 40 performs the following processing on the basis of the received compressed image. In the following, description will be made supposing that m=5, n=8, i=4, the number of food materials is 2, and food materials are cooked white rice and seaweed. The food materials, which are cooked white rice and seaweed, are arranged at predetermined positions in the container. The imaging apparatus 10 images a produced boxed meal at an inspection location along the production line. Since the food materials are individually arranged in predetermined regions in the container, the processing circuit 40 can specify the positions of the food materials in a compressed image output from the imaging apparatus 10.

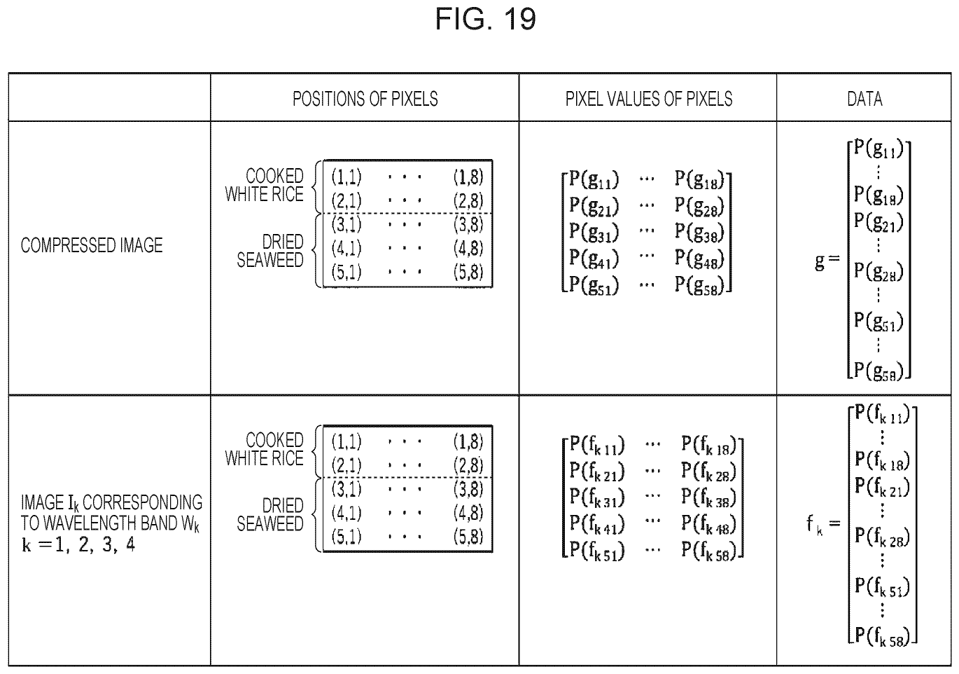

FIG. 19 illustrates the positions of pixels in a compressed image, pixel values of the pixels included in the compressed image, data g of the compressed image, the positions of pixels in an image Iₖ corresponding to the wavelength band Wₖ, pixel values of the pixels included in the image Iₖ, and data fₖ of the image Iₖ (k=1, 2, 3, 4).

In the compressed image, cooked white rice is positioned in a region defined by coordinates (1, 1), . . . , coordinates (1, 8), coordinates (2, 1), . . . , and coordinates (2, 8), and the seaweed is positioned in a region defined by coordinates (3, 1), . . . , coordinates (3, 8), . . . , coordinates (5, 1), . . . , and coordinates (5, 8).

The pixel values of pixels included in the compressed image may be expressed as

$$[ \begin{matrix}P ( {g}_{11} ) & ⋯ & P ( {g}_{18} ) \\ P ( {g}_{21} ) & ⋯ & P ( {g}_{28} ) \\ P ( {g}_{31} ) & ⋯ & P ( {g}_{38} ) \\ P ( {g}_{41} ) & ⋯ & P ( {g}_{48} ) \\ P ( {g}_{51} ) & ⋯ & P ( {g}_{58} )\end{matrix} ] \qquad ( 6 )$$

The data g of the compressed image may be expressed as

$$g = [ \begin{matrix}P ( {g}_{11} ) \\ ⋮ \\ P ( {g}_{18} ) \\ P ( {g}_{21} ) \\ ⋮ \\ P ( {g}_{28} ) \\ ⋮ \\ P ( {g}_{51} ) \\ ⋮ \\ P ( {g}_{58} )\end{matrix} ] \qquad ( 7 )$$

The image Iₖ and the image data fₖ correspond to the wavelength band Wₖ (k=1, 2, 3, 4).

In the image Iₖ, cooked white rice is positioned in a region defined by coordinates (1, 1), . . . , coordinates (1, 8), coordinates (2, 1), . . . , and coordinates (2, 8), and the seaweed is positioned in a region defined by coordinates (3, 1), . . . , coordinates (3, 8), . . . , coordinates (5, 1), . . . , and coordinates (5, 8).

The pixel values of the pixels included in the image Iₖ can be expressed as

$$[ \begin{matrix}P ( {f}_{k 11} ) & ⋯ & P ( {f}_{k 18} ) \\ P ( {f}_{k 21} ) & ⋯ & P ( {f}_{k 28} ) \\ P ( {f}_{k 31} ) & ⋯ & P ( {f}_{k 38} ) \\ P ( {f}_{k 41} ) & ⋯ & P ( {f}_{k 48} ) \\ P ( {f}_{k 51} ) & ⋯ & P ( {f}_{k 58} )\end{matrix} ] \qquad ( 8 )$$

The data fₖ of the image Iₖ may be expressed as

$${f}_{k} = [ \begin{matrix}P ( {f}_{k 11} ) \\ ⋮ \\ P ( {f}_{k 18} ) \\ P ( {f}_{k 21} ) \\ ⋮ \\ P ( {f}_{k 28} ) \\ ⋮ \\ P ( {f}_{k 51} ) \\ ⋮ \\ P ( {f}_{k 58} )\end{matrix} ] \qquad ( 9 )$$

The processing circuit 40 calculates f₁′, f₂′, f₃′, and f₄′ on the basis of Eq. (10) below.

$$g = [ \begin{matrix}P ( {g}_{11} ) \\ ⋮ \\ P ( {g}_{18} ) \\ P ( {g}_{21} ) \\ ⋮ \\ P ( {g}_{28} ) \\ ⋮ \\ P ( {g}_{51} ) \\ ⋮ \\ P ( {g}_{58} )\end{matrix} ] = {H}^{′} {f}^{′} = [ ABCD ] [ \begin{matrix}{{f}_{1}}^{′} \\ {{f}_{2}}^{′} \\ {{f}_{3}}^{′} \\ {{f}_{4}}^{′}\end{matrix} ] \qquad ( 10 )$$

Note that

$${{f}_{k}}^{′} = {[ \begin{matrix}P ( {f}_{k 11} ) \\ ⋮ \\ P ( {f}_{k 18} ) \\ P ( {f}_{k 21} ) \\ ⋮ \\ P ( {f}_{k 28} )\end{matrix} ]}_{k = 1 , 2} \qquad ( 11 )$$

$${{f}_{k}}^{′} = {[ \begin{matrix}P ( {f}_{k 31} ) \\ ⋮ \\ P ( {f}_{k 38} ) \\ P ( {f}_{k 41} ) \\ ⋮ \\ P ( {f}_{k 48} ) \\ P ( {f}_{k 51} ) \\ ⋮ \\ P ( {f}_{k 58} )\end{matrix} ]}_{k = 3 , 4}$$

$$A = [ \begin{matrix}{a}_{11} & {a}_{12} & ⋯ & {a}_{1 \; 15} & {a}_{1 \; 16} \\ ⋮ & ⋮ & & ⋯ & ⋮ \\ {a}_{40 \; 1} & {a}_{40 \; 2} & ⋯ & {a}_{40 \; 15} & {a}_{40 \; 16}\end{matrix} ]$$

$$B = [ \begin{matrix}{a}_{1 \; 41} & {a}_{1 \; 42} & ⋯ & {a}_{1 \; 55} & {a}_{1 \; 56} \\ ⋮ & ⋮ & & ⋯ & ⋮ \\ {a}_{40 \; 41} & {a}_{40 \; 42} & ⋯ & {a}_{40 \; 55} & {a}_{40 \; 56}\end{matrix} ]$$

$$C = [ \begin{matrix}{a}_{1 \; 97} & {a}_{1 \; 98} & ⋯ & {a}_{1 \; 119} & {a}_{1 \; 120} \\ ⋮ & ⋮ & & ⋯ & ⋮ \\ {a}_{40 \; 97} & {a}_{40 \; 98} & ⋯ & {a}_{40 \; 119} & {a}_{40 \; 120}\end{matrix} ]$$

$$D = [ \begin{matrix}{a}_{1 \; 137} & {a}_{1 \; 138} & ⋯ & {a}_{1 \; 159} & {a}_{1 \; 160} \\ ⋮ & ⋮ & & ⋯ & ⋮ \\ {a}_{40 \; 137} & {a}_{40 \; 138} & ⋯ & {a}_{40 \; 159} & {a}_{40 \; 160}\end{matrix} ]$$

Details of processing that the above-described processing circuit 40 performs to calculate f₁′, f₂′, f₃′, f₄′ on the basis of Eq. (10) are as follows.

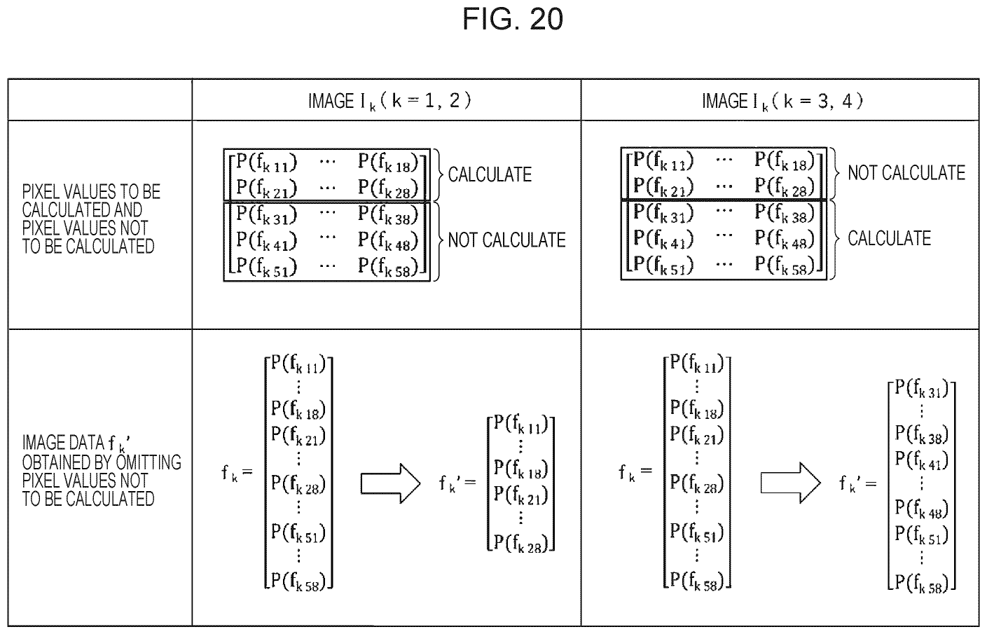

FIG. 20 illustrates pixel values to be calculated and pixel values not to be calculated by the processing circuit 40 and image data fₖ′ obtained by omitting the pixel values not to be calculated. Note that the processing circuit calculates not the image data fₖ but the image data fₖ′.

The processing circuit 40 calculates first pixel values (P(f_{1 11}), . . . , P(f_{1 18}), P(f_{1 21}), . . . , P(f_{1 28})) of first pixels included in a first region included in an image I₁ (in the image I₁, a region defined by coordinates (1, 1), . . . , coordinates (1, 8), coordinates (2, 1), . . . , and coordinates (2, 8)) corresponding to light of a first wavelength band W₁ (for example, 520±5 nm) from a subject (for example, a produced boxed meal) (see cooked white rice at 520 nm in FIGS. 15A and 15B).

The processing circuit 40 calculates second pixel values (P(f_{2 11}), . . . , P(f_{2 18}), P(f_{2 21}), . . . , P(f_{2 28})) of second pixels included in a second region included in an image I₂ (in the image I₂, a region defined by coordinates (1, 1), . . . , coordinates (1, 8), coordinates (2, 1), . . . , and coordinates (2, 8)) corresponding to light of a second wavelength band W₂ (for example, 620±5 nm) from the boxed meal (see cooked white rice at 620 nm in FIGS. 15A and 15B).

The processing circuit 40 calculates third pixel values (P(f_{3 31}), . . . , P(f_{3 38}), P(f_{3 41}), . . . , P(f_{3 48}), P(f_{3 51}), . . . , P(f_{3 58})) of third pixels included in a third region included in an image I₃ (in the image I₃, a region defined by coordinates (3, 1), . . . , coordinates (3, 8), coordinates (4, 1), . . . , coordinates (4, 8), coordinates (5, 1), . . . , and coordinates (5, 8)) corresponding to light of a third wavelength band W₃ (for example, 500±5 nm) from the boxed meal (see dried seaweed at 500 nm in FIGS. 16A and 16B).

The processing circuit 40 calculates fourth pixel values (P(f_{4 31}), . . . , P(f_{4 38}), P(f_{4 41}), . . . , P(f_{4 48}), P(f_{4 51}), . . . , P(f_{4 58})) of fourth pixels included in a fourth region included in an image I₄ (in the image I₄, a region defined by coordinates (3, 1), . . . , coordinates (3, 8), coordinates (4, 1), . . . , coordinates (4, 8), coordinates (5, 1), . . . , and coordinates (5, 8)) corresponding to light of a fourth wavelength band W₄ (for example, 660±5 nm) from the boxed meal (see dried seaweed at 660 nm in FIGS. 16A and 16B).

The first region and the second region correspond to the region where cooked white rice included in the boxed meal is arranged.

The third region and the fourth region correspond to the region where seaweed included in the boxed meal is arranged.

The processing circuit 40 does not calculate pixel values (P(f_{1 31}), . . . , P(f_{1 38}), P(f_{1 41}), . . . , P(f_{1 48}), P(f_{1 51}), . . . , P(f_{1 58})) of pixels included in a region other than the first region and included in the image I₁ (in the image I₁, a region defined by coordinates (3, 1), . . . , coordinates (3, 8), coordinates (4, 1), . . . , coordinates (4, 8), coordinates (5, 1), . . . , and coordinates (5, 8)).

The processing circuit 40 does not calculate pixel values (P(f_{2 31}), . . . , P(f_{2 38}), P(f_{2 41}), . . . , P(f_{2 48}), P(f_{2 51}), . . . , P(f_{2 58})) of pixels included in a region other than the second region and included in the image I₂ (in the image I₂, a region defined by coordinates (3, 1), . . . , coordinates (3, 8), coordinates (4, 1), . . . , coordinates (4, 8), coordinates (5, 1), . . . , and coordinates (5, 8)).

The processing circuit 40 does not calculate pixel values (P(f_{3 11}), . . . , P(f_{3 18}), P(f_{3 21}), . . . , P(f_{3 28})) of pixels included in a region other than the third region and included in the image I₃ (in the image I₃, a region defined by coordinates (1, 1), . . . , coordinates (1, 8), coordinates (2, 1), . . . , and coordinates (2, 8)).

The processing circuit 40 does not calculate pixel values (P(f_{4 11}), . . . , P(f_{4 18}), P(f_{4 21}), . . . , P(f_{4 28})) of pixels included in a region other than the fourth region and included in the image I₄ (in the image I₄, a region defined by coordinates (1, 1), . . . , coordinates (1, 8), coordinates (2, 1), . . . , and coordinates (2, 8)).

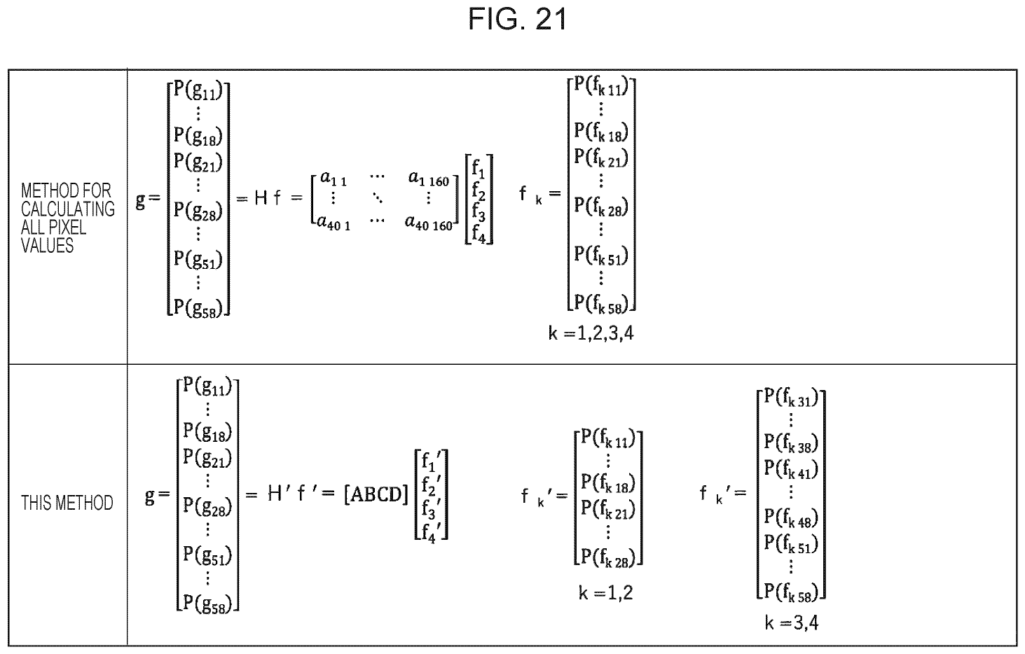

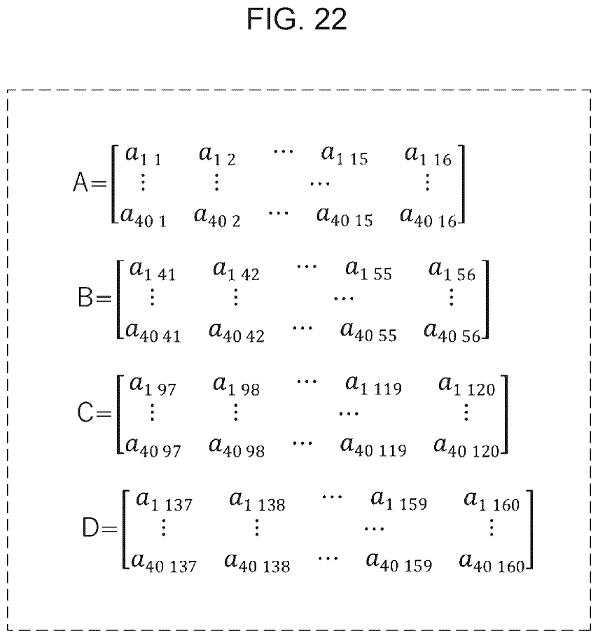

FIG. 21 illustrates a comparison made for f, H, f′, and H′. FIG. 22 illustrates A, B, C, and D included in FIG. 21.

f′ includes 80 (=2×8×2+3×8×2) pixel values; however, f includes 160 (=5×8×4) pixel values. Thus, the amount of calculation for obtaining f′ is half of that for obtaining f. H is a matrix having 40 rows and 160 columns; however, H′ is a matrix having 40 rows and 80 columns. That is, the number of elements of H′ is half that of H.

This completes description of details of processing in which the processing circuit 40 calculates f₁′, f₂′, f₃′, and f₄′ on the basis of Eq. (10).

The processing circuit 40 determines, on the basis of the first pixel values (P(f_{1 11}), . . . , P(f_{1 18}), P(f_{1 21}), . . . , P(f_{1 28})), whether the first region included in the image I₁ (in the image I₁, the region defined by coordinates (1, 1), . . . , coordinates (1, 8), coordinates (2, 1), . . . , and coordinates (2, 8)) corresponding to light of the first wavelength band W₁ (for example, 520±5 nm) from the boxed meal includes one or more foreign objects (see FIGS. 15A and 15B and refer to related description thereto).

When each of the first pixel values (P(f_{1 11}), . . . , P(f_{1 18}), P(f_{1 21}), . . . , P(f_{1 28})) is included in a predetermined range, the processing circuit 40 may determine that the first region does not include a foreign object. In cases other than this one, the processing circuit 40 may determine that the first region includes a foreign object. It is sufficient that the predetermined region be determined on the basis of the data in FIG. 15A.

The processing circuit 40 determines, on the basis of the second pixel values (P(f_{2 11}), . . . , P(f_{2 18}), P(f_{2 21}), . . . , P(f_{2 28})), whether the second region included in the image I₂ (in the image I₂, the region defined by coordinates (1, 1), . . . , coordinates (1, 8), coordinates (2, 1), . . . , and coordinates (2, 8)) corresponding to light of the second wavelength band W₂ (for example, 620±5 nm) from the boxed meal includes one or more foreign objects (see FIGS. 15A and 15B and refer to related description thereto).

When each of the second pixel values (P(f_{2 11}), . . . , P(f_{2 18}), P(f_{2 21}), . . . , P(f_{2 28})) is included in a predetermined range, the processing circuit 40 may determine that the second region does not include a foreign object. In cases other than this one, the processing circuit 40 may determine that the second region includes a foreign object. It is sufficient that the predetermined region be determined on the basis of the data in FIG. 15A.

In a case where the first region does not include a foreign object and where the second region does not include a foreign object, the processing circuit 40 determines that the cooked white rice (that is, the region where cooked white rice is arranged) included in the boxed meal, which is an object to be inspected, does not include a foreign object. In a case where the first region includes a foreign object, where the second region includes a foreign object, or where the first region include a foreign object, and the second region includes a foreign object, the processing circuit 40 determines that the cooked white rice (that is, the region where cooked white rice is arranged) included in the boxed meal, which is an object to be inspected, includes a foreign object (see FIGS. 15A and 15B and refer to related description thereto).

The processing circuit 40 determines, on the basis of the third pixel values (P(f_{3 31}), . . . , P(f_{3 38}), P(f_{3 41}), . . . , P(f_{3 48}), P(f_{3 51}), . . . , P(f_{3 58})) of the third pixels, whether the third region included in the image I₃ corresponding to light of the third wavelength band W₃ (for example, 500±5 nm) from the boxed meal (in the image I₃, the region defined by coordinates (3, 1), . . . , coordinates (3, 8), coordinates (4, 1), . . . , coordinates (4, 8), coordinates (5, 1), . . . , and coordinates (5, 8)) includes one or more foreign objects (see FIGS. 16A and 16B and refer to related description thereto).

When each of the third pixel values (P(f_{3 31}), . . . , P(f_{3 38}), P(f_{3 41}), . . . , P(f_{3 48}), P(f_{3 51}), . . . , P(f_{3 58})) is included in a predetermined range, the processing circuit 40 may determine that the third region does not include a foreign object. In cases other than this one, the processing circuit 40 may determine that the third region includes a foreign object. It is sufficient that the predetermined region be determined on the basis of the data in FIG. 16A.

The processing circuit 40 determines, on the basis of the fourth pixel values (P(f_{4 31}), . . . , P(f_{4 38}), P(f_{4 41}), . . . , P(f_{4 48}), P(f_{4 51}), . . . , P(f_{4 58})) of the fourth pixels, whether the fourth region included in the image I₄ corresponding to light of the fourth wavelength band W₄ (for example, 660±5 nm) from the boxed meal (in the image I₄, the region defined by coordinates (3, 1), . . . , coordinates (3, 8), coordinates (4, 1), . . . , coordinates (4, 8), coordinates (5, 1), . . . , and coordinates (5, 8)) includes one or more foreign objects (see FIGS. 16A and 16B and refer to related description thereto).

When each of the fourth pixel values (P(f_{4 31}), . . . , P(f_{4 38}), P(f_{4 41}), . . . , P(f_{4 48}), P(f_{4 51}), . . . , P(f_{4 58})) is included in a predetermined range, the processing circuit 40 may determine that the fourth region does not include a foreign object. In cases other than this one, the processing circuit 40 may determine that the fourth region includes a foreign object. It is sufficient that the predetermined region be determined on the basis of the data in FIG. 16A.

In a case where the third region does not include a foreign object and where the fourth region does not include a foreign object, the processing circuit 40 determines that the seaweed (that is, the region where seaweed is arranged) included in the boxed meal, which is an object to be inspected, does not include a foreign object. In a case where the third region includes a foreign object, where the fourth region includes a foreign object, or where the third region include a foreign object, and the fourth region includes a foreign object, the processing circuit 40 determines that the seaweed (that is, the region where seaweed is arranged) included in the boxed meal, which is an object to be inspected, includes a foreign object (see FIGS. 16A and 16B and refer to related description thereto).

### Second Example of Another Embodiment

Each embodiment to which various modifications that one skilled in the art can conceive of are added, and embodiments obtained by combining constituent elements from different embodiments may also be included in the scope of one or more aspects of the present disclosure as long as the embodiments do not depart from the gist of the present disclosure.

The technology according to the present disclosure is useful, for example, for foreign object inspection for industrial products and processed food products. The technology according to the present disclosure can be used for, for example, in-line inspection that does not involve a visual inspection.

What is claimed is:

1. A method for detecting a foreign object on or in an object, the method being executed by a computer, comprising:
acquiring image data of the object including information regarding four or more bands;
extracting, for individual regions of the object, partial image data corresponding to at least one band among the four or more bands from the image data;
performing, for each region, a detection operation for detecting, based on the partial image data, a foreign object on or in the object; and
outputting data representing a detection result,
wherein the at least one band is selected in accordance with each of the regions.

2. The method according to claim 1, wherein
the acquiring includes acquiring hyperspectral image data representing images of the object for the four or more bands.

3. The method according to claim 1, wherein the acquiring includes acquiring compressed image data obtained by compressing image information regarding the object for the four or more bands into one image.

4. The method according to claim 3, wherein
the extracting includes reconstructing, from the compressed image data, the partial image data corresponding to the at least one band.

5. The method according to claim 4, wherein
the compressed image data is acquired by imaging the object through a filter array,
the filter array has filters arranged two-dimensionally,
transmission spectra of at least two or more filters among the filters differ from each other,
the reconstructing includes reconstructing the partial image data using at least one reconstruction table corresponding to the at least one band, and
the reconstruction table represents a spatial distribution of luminous transmittance of each band for the filter array in each of the regions.

6. The method according to claim 1 further comprising:
acquiring region classification data corresponding to a type of the object,
wherein the regions are determined based on the image data and the region classification data.

7. The method according to claim 6, wherein
the at least one band is selected based on the region classification data.

8. The method according to claim 6, wherein
the region classification data includes region information for determining the regions,
the method further comprising:
acquiring, based on the region classification data, reference data including information regarding a band corresponding to the region information,
wherein the at least one band is selected based on the reference data.

9. The method according to claim 6, further comprising:
updating the region classification data; and
updating the regions.

10. The method according to claim 9, further comprising:
updating the at least one band.

11. The method according to claim 6, wherein
the object is an industrial product, and
the region classification data includes data representing a layout diagram of parts of the industrial product.

12. The method according to claim 6, wherein
the object is a processed food product, and
the region classification data includes data representing a layout diagram of ingredients of the processed food product.

13. The method according to claim 6, wherein
the region classification data is generated by performing image recognition processing on an image of the object, on or in which a foreign object is not present.

14. A processing apparatus comprising:
a processor; and
a memory in which a computer program that the processor executes is stored, wherein
in order to detect a foreign object on or in an object, the computer program causes the processor to execute
acquiring image data of the object including information regarding four or more bands,
extracting, for individual regions of the object, partial image data corresponding to at least one band among the four or more bands from the image data,
performing, for each region, a detection operation for detecting, based on the partial image data, a foreign object on or in the object, and
outputting data representing a detection result,
wherein the at least one band is selected in accordance with each of the regions.
